(19) United States
(12) Patent Application Publication
(10) Pub. No.: US 2012/0069069 A1
(43) Pub. Date: Mar. 22, 2012

(54) LIQUID DISCHARGING APPARATUS

(76) Inventors: Kiyosuke Suzuki, Tokyo (JP); Toshio Shirai, Kanagawa (JP); Yuichiro Ikemoto, Kanagawa (JP)

(21) Appl. No.: 13/233,857

(22) Filed: Sep. 15, 2011

(30) Foreign Application Priority Data
Sep. 21, 2010 (JP) P2010-211414

(51) Int. Cl. B41J 29/38

(52) U.S. Cl. 347/9

(57) ABSTRACT

A liquid discharging apparatus includes a liquid discharging head having liquid discharging nozzles; a platen that retains a recording sheet; a liquid detection unit which can move between the liquid discharging head and the platen and detects liquid discharge states from the liquid discharging nozzles; and a unit driving mechanism which moves the liquid detection unit, wherein the liquid detection unit moves from a detection start end to a detection termination end at the time of detection of the liquid discharge states, and at the time of movement of the liquid detection unit, liquid discharge operations from nozzle orifices in a certain area located at a certain distance from a detection position are performed ahead of detection by the liquid detection unit, and at the time of detection by the liquid detection unit, a liquid discharge operation from the nozzle orifice that becomes a detection target is performed again.

### BACKGROUND

The present disclosure relates to a technical field of a liquid discharging apparatus. Specifically, the present disclosure relates to a technical field of attaining shortening of a detection time or the like by performing discharge operations of liquid from nozzle orifices ahead of detection by a liquid detection unit at the time of movement of the liquid detection unit.

A liquid discharging apparatus such as an ink jet printer is provided with a platen which retains a recording sheet that is transported and a liquid discharging head which discharges liquid such as ink onto the recording sheet retained on the platen, thereby performing recording.

As for the liquid discharging apparatus, a so-called serial head type liquid discharging apparatus, in which a liquid discharging head moves in a direction (a main scanning direction) perpendicular to the transport direction (a sub-scanning direction) of the recording sheet, thereby performing recording, and a so-called line head type liquid discharging apparatus, in which recording is performed only in the transport direction of the recording sheet by using a fixed liquid discharging head having a length covering the full width of the recording sheet, are present.

In such a liquid discharging apparatus, if ink is thickened by drying in a liquid discharging nozzle of the liquid discharging head or dust or the like is attached to a nozzle orifice, the discharge speed of ink is lowered or the discharge direction of ink is changed and furthermore, abnormal discharge such as inability to discharge sometimes occurs.

Since the abnormal discharge causes deterioration of image quality, a discharge recovery treatment for performing prevention of the abnormal discharge or recovery is carried out. As for the discharge recovery treatment, there is, for example, a so-called idling discharge in which a discharge operation of ink is performed at times other than the time of recording on the recording sheet, cleaning by wiping away ink, dust, or the like of the nozzle orifices by using a cleaning roller or the like.

As for the liquid discharging apparatus, there is a liquid discharging apparatus which is provided with a liquid discharging unit for detecting the presence or absence of abnormal discharge of a liquid discharging nozzle and specifying the liquid discharging nozzle in which abnormal discharge has occurred (refer to Japanese Unexamined Patent Application Publication No. 2000-272134, for example). With respect to the liquid discharging nozzle in which abnormal discharge has been detected, the above-mentioned discharge recovery treatment is performed.

In the liquid discharging apparatus described in Japanese Unexamined Patent Application Publication No. 2000-272134, a light emitting section and a light sensing section are disposed at the liquid discharging unit, and the discharge speed of ink is measured by using the fact that a light-receiving level in the light sensing section changes when discharged ink (a liquid droplet) traverses a luminous flux emitted from the light emitting section. In a case where the discharge speed of ink is measured and the discharge speed is slower than a predetermined speed or a case where discharge of ink is not detected, thereby leading to non-discharge, it is detected that the relevant liquid, discharging nozzle has abnormal discharge.

Detection of such abnormal discharge is performed, for example, after power-on, when the liquid discharging head has not been used for a long period of time, or the like.

### SUMMARY

Incidentally, since the liquid discharging nozzle of the liquid discharging head gives rise to abnormal discharge by thickening due to drying or attachment of dust or the like, as described above, it is desirable to perform detection of the presence or absence of abnormal discharge of the liquid discharging nozzle by a liquid detection unit after the discharge recovery treatment is performed.

By detecting the presence or absence of abnormal discharge of the liquid discharging nozzle after the discharge recovery treatment is performed, the number of liquid discharging nozzles which are detected as abnormal discharge is reduced, so that simplification and speed-up of an operation of the discharge recovery treatment which is performed on the liquid discharging nozzle regarded as abnormal discharge after detection is attained.

However, if detection of the presence or absence of abnormal discharge of the liquid discharging nozzle by the liquid detection unit is performed after the discharge recovery treatment is performed, a time to perform detection of the presence or absence of abnormal discharge of the liquid discharging nozzle by the liquid detection unit is necessary in addition to a time to performed the discharge recovery treatment, so that an operating time in the liquid discharging apparatus is prolonged, whereby it takes a long time, for example, after power-on and until a recording operation is started with respect to the recording sheet.

Therefore, it is desirable to attain simplification and speed-up of an operation of the discharge recovery treatment which is performed on the liquid discharging nozzle regarded as abnormal discharge after detection and also attain shortening of a detection time.

According to an embodiment of the present disclosure, there is provided a liquid discharging apparatus including: a liquid discharging head in which a plurality of liquid discharging nozzles which discharge liquid onto a recording sheet on the basis of image information are arranged and which has liquid discharging surfaces in which each nozzle orifice of the plurality of liquid discharging nozzles is arranged; a platen that is disposed to face the liquid discharging surfaces of the liquid discharging head and retains the recording sheet in a state where the recording sheet faces the liquid discharging surfaces; a liquid detection unit which is made to be able to move between the liquid discharging head and the platen in a state where the liquid detection unit faces the liquid discharging surfaces and which detects the discharge states of liquid from the liquid discharging nozzles at the time of movement; and a unit driving mechanism which moves the liquid detection unit in a state where the liquid detection unit faces the liquid discharging surfaces, wherein at the time of detection of the discharge states of liquid from the liquid discharging nozzles, the liquid detection unit is moved from a detection start end in which detection is started up to a detection termination end in which detection is finished, and at the time of movement of the liquid detection unit, discharge operations of liquid from the nozzle orifices that are present in a certain area located at a certain distance in the detection termination end side from a detection position are performed ahead of detection by the liquid detection unit, and at the time of detection by the liquid detection unit, a discharge operation of liquid from the nozzle orifice of the liquid discharging nozzle that becomes a detection target is performed again.

Therefore, in the liquid discharging apparatus according to the embodiment, at the time of movement of the liquid detection unit, the discharge operations of liquid from the nozzle orifices which precede detection are performed and also the discharge states of liquid from the liquid discharging nozzles are detected.

In the above, liquid discharging apparatus according to the embodiment of the present disclosure, it is desirable that light emitting sections which emit detection lights that detect the discharge states of liquid from the liquid discharging nozzles and light sensing sections which receive the detection lights emitted from the light, emitting sections be disposed at the liquid detection unit, the light emitting sections and the light sensing sections be disposed being spaced apart in a direction perpendicular to a movement direction of the liquid detection unit and perpendicular to a discharge direction of liquid, a detection sensor be constituted by the combination of the light emitting section and the light sensing section, and the detection sensor be arranged in a plurality in the movement direction.

The detection sensor is arranged in a plurality in the movement direction of the liquid detection unit, whereby it becomes possible to respectively detect, different liquid discharging nozzles provided at the liquid discharging head by a plurality of detection sensors.

In the above liquid discharging apparatus according to the embodiment of the present disclosure, it is desirable that the light emitting sections and the light sensing sections be alternately arranged in the movement direction.

The light emitting sections and the light sensing sections are alternately arranged in the movement direction of the liquid detection unit, whereby the detection light emitted from the light emitting section is not incident on the light sensing section which is located in the movement direction of the liquid detection unit, so that a mutual optical interference does not occur between the detection sensors.

In the above liquid discharging apparatus according to the embodiment of the present disclosure, it is desirable that a fixed line head which extends in a direction perpendicular to the movement direction of the liquid detection unit be used as the liquid discharging head.

By using the fixed line head which extends in a direction perpendicular to the movement direction of the liquid detection unit as the liquid discharging head, the liquid detection unit is moved in the extending direction of the liquid discharging head.

In the above liquid discharging apparatus according to the embodiment of the present disclosure, it is desirable that the liquid detection unit include a discharge detection section in which the light emitting sections and the light sensing sections are arranged and a cleaning section which cleans the liquid discharging surfaces of the liquid discharging head and cleaning, by the cleaning section be performed ahead of detection by the discharge detection section at the time of movement of the liquid detection unit.

The discharge detection section and the cleaning section are provided at the liquid detection unit and cleaning by the cleaning section be performed ahead of detection by the discharge, detection section at the time of movement of the liquid detection unit, whereby detection by the discharge detection section is performed on the liquid discharging nozzles subjected to cleaning.

In the above liquid discharging apparatus according to the embodiment of the present disclosure, it is desirable that the cleaning by the cleaning section be performed ahead of the discharge operations of liquid from the nozzle orifices which precede detection by the liquid detection unit.

The cleaning by the cleaning section is performed ahead of the discharge operations of liquid from the nozzle orifices which precede detection by the liquid detection unit, whereby preceding discharge operations are performed in the liquid discharging nozzles subjected to cleaning and detection is performed on the liquid discharging nozzles in which the preceding discharge operations have been performed.

In the above liquid discharging apparatus according to the embodiment of the present disclosure, it is desirable that an absorber which absorbs liquid that is discharged from the liquid discharging nozzles be disposed at the liquid detection unit.

The absorber which absorbs liquid that is discharged from the liquid discharging nozzles is disposed at the liquid detection unit, whereby it becomes possible to absorb liquid that is discharged from the liquid discharging nozzles before it becomes mist.

In the above liquid discharging apparatus according to the embodiment of the present disclosure, it is desirable that the liquid discharging head include a plurality of module heads in which colors that are discharged from the liquid discharging nozzles are respectively different and which are adjacently disposed in a direction perpendicular to the movement, direction of the liquid detection unit and perpendicular to the discharge direction of a liquid, a discharge operation of liquid from each liquid discharging nozzle of each module head be intermittently performed once in order, and a discharge operation of a liquid from each liquid discharging nozzle of each module head be performed when a discharge operation of liquid from each liquid discharging nozzle of another module head is not performed.

The discharge operation of liquid from each liquid discharging nozzle of each module head is intermittently performed once in order and the discharge operation of liquid from each liquid discharging nozzle is performed when a discharge operation of liquid from each liquid discharging nozzle of another module head is not performed, whereby the number of times of the discharge operations of liquid from each liquid discharging nozzle is reduced.

In the above liquid discharging apparatus according to the embodiment of the present disclosure, it is desirable that the liquid discharging head include a plurality of module heads in which colors that are discharged from the liquid discharging nozzles are respectively different and which are adjacently disposed in a direction perpendicular to the movement direction of the liquid detection unit and perpendicular to the discharge direction of liquid, and when the number of module heads is set to be n, a discharge operation of liquid from each liquid discharging nozzle of each module head be performed n times in order, and the start of discharge operations of liquid of the respective module heads adjacently disposed be performed being delayed once in order.

The discharge operation of liquid from each liquid discharging nozzle is performed n times in order and the start of discharge operations of liquid of the respective module heads adjacently disposed is performed being delayed once in order, whereby there is a possibility that the liquid discharging nozzle having a discharge defect may return to normal while n discharge operations are performed.

The liquid discharging apparatus according to the embodiment of the present disclosure includes: the liquid discharging head in which a plurality of liquid discharging nozzles which discharge liquid onto a recording sheet on the basis of image information are arranged and which has liquid discharging surfaces in which each nozzle orifice of the plurality of liquid discharging nozzles is arranged; the platen that is disposed to face the liquid discharging surfaces of the liquid discharging head and retains the recording sheet in a state where the recording sheet faces the liquid discharging surfaces; the liquid detection unit which is made to be able to move between the liquid discharging head and the platen in a state where the liquid detection unit faces the liquid discharging surfaces and which detects the discharge states of liquid from the liquid discharging nozzles at the time of movement; and the unit driving mechanism which moves the liquid detection unit in a state where the liquid detection unit faces the liquid, discharging surfaces, wherein at the time of detection of the discharge states of liquid from the liquid discharging nozzles, the liquid detection unit is moved from a detection start end in which detection is started up to a detection termination end in which detection is finished, and at the time of movement of the liquid detection unit, discharge operations of liquid from the nozzle orifices that are present in a certain area located at a certain distance in the detection termination end side from a detection position are performed ahead of detection by the liquid detection unit, and at the time of detection by the liquid detection unit, a discharge operation of liquid from the nozzle orifice of the liquid discharging nozzle that becomes a detection target is performed again.

Therefore, a liquid discharge operation which is a discharge recovery treatment for recovering normal discharge of liquid from the liquid discharging nozzle and detection by the discharge detection section are performed at the time of movement of the liquid detection unit, so that it is possible to attain simplification and speed-up of an operation of the discharge recovery treatment which is performed on the liquid discharging nozzle regarded as having a discharge defect after detection and also attain shortening of a detection time.

According to the embodiment of the present disclosure, the light emitting sections which emit detection lights which detect the discharge states of liquid from the liquid discharging nozzles and the light sensing sections which receive the detection lights emitted from the light emitting sections are disposed at the liquid detection unit, the light emitting sections and the light sensing sections are disposed being spaced apart in a direction perpendicular to the movement direction of the liquid detection unit and perpendicular to the discharge direction of the liquid, the detection sensor is constituted by the combination of the light emitting section and the light sensing section, and the detection sensor is arranged in a plurality in the movement direction.

Therefore, it is possible to respectively detect different liquid discharging nozzles provided at the liquid discharging head by a plurality of detection sensors and it is possible to attain improvement in detection speed.

According to the embodiment of the present disclosure, the light emitting sections and the light sensing sections are alternately arranged in the movement direction.

Therefore, since a mutual optical interference does not occur between the plurality of detection sensors, it is possible to shorten the distance between the detection sensors in the movement direction of the liquid detection unit, so that it is possible to attain a reduction in the size of the liquid discharging apparatus due to a reduction in the size of the liquid detection unit.

According to the embodiment of the present disclosure, the fixed line head which extends in a direction perpendicular to the movement direction of the liquid detection unit is used as the liquid discharging head.

Therefore, since the liquid discharging head is fixed, it is possible to secure excellent positional accuracy of the liquid detection unit with respect to the liquid discharging head and it is possible to attain improvement in detection accuracy by the liquid detection unit.

According to the embodiment of the present, disclosure, the liquid detection unit includes the discharge detection section in which the light emitting sections and the light sensing sections are arranged and the cleaning section which cleans the liquid discharging surfaces of the liquid discharging head, and cleaning by the cleaning section is performed ahead of detection by the discharge detection section at the time of movement of the liquid detection unit.

Therefore, since the number of liquid discharging nozzles which are detected as having a discharge defect by the discharge detection section is reduced, it is possible to attain simplification and speed-up of an operation of the discharge recovery treatment such as idling discharge or cleaning which is performed on the liquid discharging nozzle regarded as having a discharge defect after detection.

According to the embodiment of the present disclosure, the cleaning by the cleaning section is performed ahead of the discharge operations of liquid from the nozzle orifices which precede detection by the liquid detection unit.

Therefore, since the number of liquid discharging nozzles which are detected as having a discharge defect is further reduced, it is possible to attain further simplification and further speed-up of an operation of the discharge recovery treatment such as idling discharge or cleaning which is performed on the liquid discharging nozzle regarded as having a discharge defect after detection.

According to the embodiment of the present disclosure, the absorber which absorbs liquid that is discharged from the liquid discharging nozzles is disposed at the liquid detection unit.

Therefore, generation of false detection in the liquid detection unit due to the presence of mist is prevented and it is possible to prevent contamination of the internal structure of the liquid discharging apparatus by mist.

According to the embodiment of the present disclosure, the liquid discharging head includes a plurality of module heads in which colors that are discharged from the liquid discharging nozzles are respectively different and which are adjacently disposed in a direction perpendicular to the movement direction of the liquid detection unit and perpendicular to the discharge direction of liquid, a discharge operation of liquid from each liquid discharging nozzle, of each module head is intermittently performed once in order, and a discharge operation of liquid from each liquid discharging nozzle of each module head is performed when a discharge operation of liquid, from each liquid discharging nozzle of another module head is not performed.

Therefore, the fewer number of times of the discharge operations of liquid from each liquid discharging nozzles of the module head is necessary, so that it is possible to attain simplification of the detection operation, and also the amount of discharged liquid is small, so that it is possible to attain a reduction in the amount of consumption of liquid.

According to the embodiment of the present disclosure, the liquid discharging head includes a plurality of module heads in which colors that are discharged from the liquid discharging nozzles are respectively different and which are adjacently disposed in a direction perpendicular to the movement direction of the liquid detection unit and perpendicular to the discharge direction of liquid, and when the number of module heads is set to be n, a discharge operation of liquid from each liquid discharging nozzle of each module head is performed n times in order, and the start of discharge operations of liquid of the respective module heads adjacently disposed are performed being delayed once in order.

Therefore, there is a possibility that the liquid discharging nozzle having a discharge defect may return to normal while n discharge operations are performed, so that it is possible to reduce the number of liquid discharging nozzles having a discharge defect.

### BRIEF DESCRIPTION OF THE DRAWINGS

FIG. 1 is a diagram illustrating a liquid discharging apparatus according to an embodiment of the present disclosure along with FIGS. 2 to 23 and a schematic side view of the liquid discharging apparatus.

FIG. 2 is a schematic diagram illustrating a positional relationship between a liquid discharging block, a platen, a suction section, and a liquid detection unit.

FIG. 3 is a bottom view illustrating a portion of the liquid discharging block.

FIG. 4 is a perspective view of the liquid detection unit.

FIG. 5 is an enlarged perspective view of a discharge detection section.

FIG. 6 is an enlarged perspective view illustrating optical paths or the like in detection sensors.

FIG. 7 is a conceptual diagram illustrating the relationship between two detection sensors, or the like.

FIG. 8 is a conceptual diagram illustrating an example in which the shape of an absorber is changed.

FIG. 9 is a perspective view illustrating the liquid detection unit and a unit driving mechanism.

FIG. 10 is a side view illustrating the liquid detection unit and the unit driving mechanism.

FIG. 11 is a perspective view illustrating a positional relationship between ink droplets which become detection targets with respect to the optical paths of detection lights which are emitted from light emitting sections and ink droplets in the preceding discharge.

FIG. 12 is a perspective view illustrating another positional relationship between ink droplets which become detection targets with respect to the optical paths of the detection lights which are emitted from light emitting sections and ink droplets in the preceding discharge.

FIG. 13 is a conceptual diagram illustrating a positional relationship between two detection sensors and a module head.

FIGS. 14A to 14E are conceptual diagrams illustrating sequence of an operation when a detection operation by the discharge detection section is performed.

FIG. 15 is a conceptual diagram illustrating a detection operation when a discharge operation of ink is intermittently performed in the liquid discharging nozzles of two module heads.

FIG. 16 is a conceptual diagram illustrating a detection operation when a discharge operation of ink is intermittently performed in the liquid discharging nozzles of four module heads.

FIG. 17 is a conceptual diagram illustrating a detection operation when a discharge operation of ink is performed twice in the liquid discharging nozzles of two module heads.

FIG. 18 is a conceptual diagram, illustrating a detection operation when a discharge operation of ink is performed four times in the liquid discharging nozzles of four module heads.

FIGS. 19A to 19D are graph charts illustrating a change in detection level with respect to the number of nozzles which are driven.

FIG. 20 is a conceptual diagram illustrating a detection operation when a discharge operation of ink is intermittently performed twice in the liquid discharging nozzles of two module heads.

FIG. 21 is a conceptual diagram illustrating a detection operation when a discharge operation of ink is intermittently performed twice in the liquid discharging nozzles of four module heads.

FIGS. 22A to 22D are graph charts illustrating a change in detection level with respect to the number of ink droplets which are dropped.

FIG. 23 is a conceptual diagram illustrating an example of a detection operation on overlapping portions of head chips.

### DETAILED DESCRIPTION OF EMBODIMENTS

Hereinafter, a liquid discharging apparatus according to an embodiment of the present disclosure will be described according to the accompanying drawings. In addition, an embodiment described below is an example in which the present disclosure is applied to a liquid discharging apparatus of a so-called line head type which includes a fixed liquid discharging head having a length covering the full width of a recording sheet and performs recording only in the transport direction of the recording sheet.

In addition, the application scope of the present disclosure is not limited to the line head type liquid discharging apparatus and it is also possible to apply the present disclosure to, for example, a serial head type, liquid discharging apparatus which performs, recording by moving a liquid discharging, head in the width direction of the recording sheet.

Configuration of Liquid Discharging Apparatus

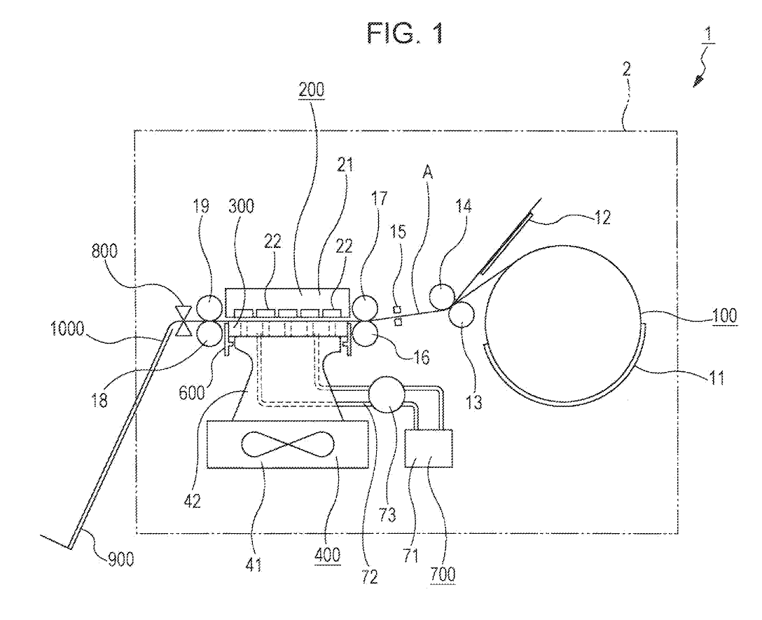

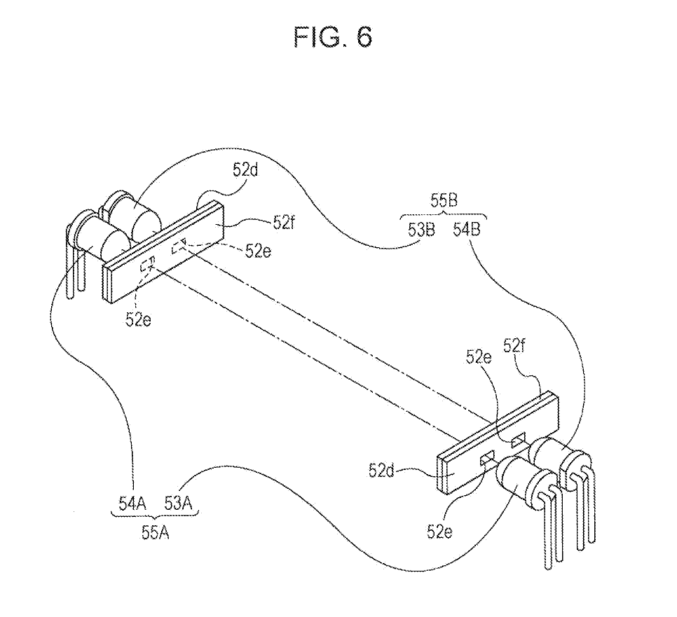

First, the configuration of the liquid discharging apparatus will be described (refer to FIGS. 1 to 10).

The necessary respective sections of a liquid discharging apparatus 1 are disposed inside and outside an outer housing 2 (refer to FIG. 1).

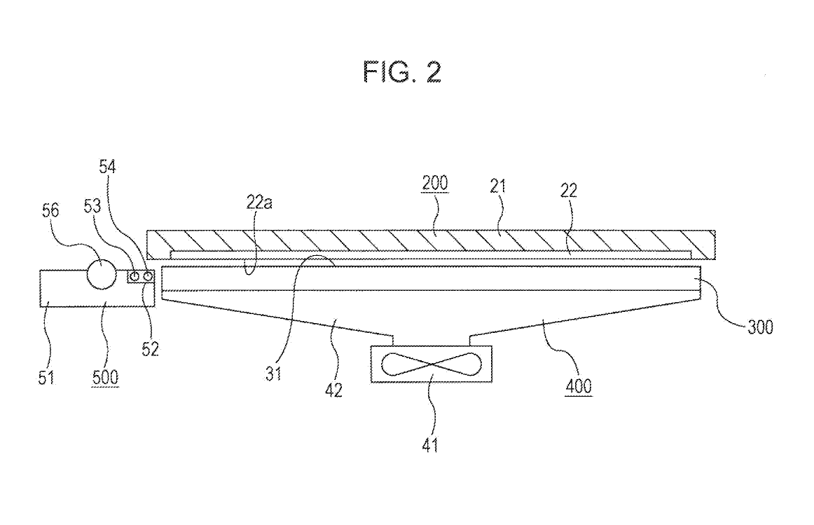

The liquid discharging apparatus 1 includes a paper feed section 100, a liquid discharging block 200, a platen 300, a suction section 400, a liquid detection unit 500, a capping section 600, a moisturizer supply section 700, a cutter 800, and a paper discharge section 900, as shown in FIGS. 1 and 2.

The paper feed section 100 supplies cut paper and rolled paper which are used as a recording sheet 1000. The paper feed section 100 is provided with a rolled paper feed tray 11 in which the rolled paper as the recording sheet 1000 is loaded and a cut paper manual feed tray 12 in which the cut paper as the recording sheet 1000 is loaded.

The liquid discharging block 200 has a function of recording an image on the recording sheet 1000 which is fed and transported.

The liquid discharging block 200 has a line type liquid discharging head (line head) 21, the smaller width of which is wider than the width of the recording sheet 1000, and which extends in the width direction (a main scanning direction) of the recording sheet 1000.

The liquid discharging head 21 has a configuration in which module heads 22, 22, . . . which respectively discharge liquid (ink) of a plurality of different colors are disposed adjacent to each other in a sub-scanning direction (the transport direction of the recording sheet 1000).

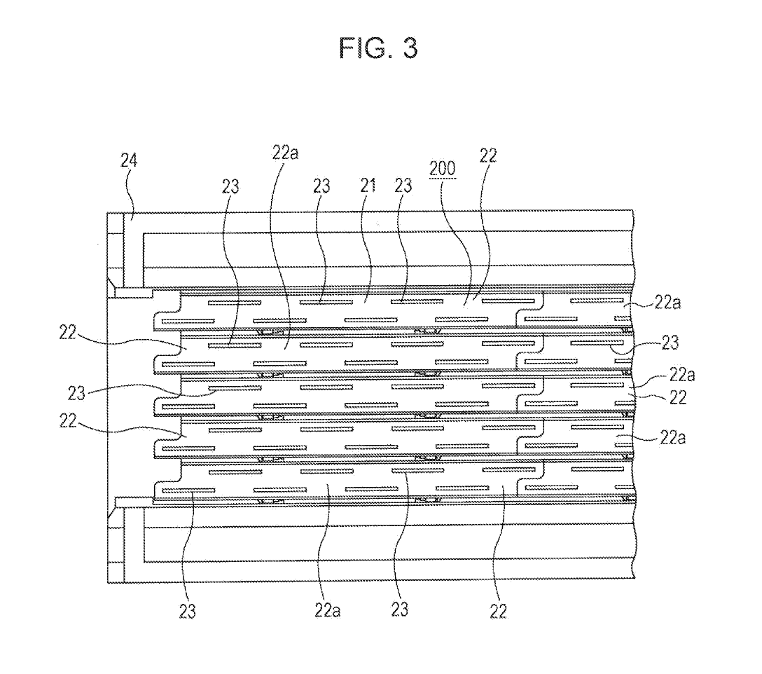

The lower surfaces of the module heads 22, 22, . . . are respectively formed as liquid discharging surfaces 22a, 22a, . . . which face the upper surface of the platen 300 (refer to FIG. 3). At each liquid discharging face 22a, a plurality of head chips 23, 23, . . . are arranged in a zigzag manner, and at each of the head chips 23, 23, . . . a plurality of minute nozzle orifices of liquid discharging nozzles (not shown) which respectively discharge ink are arranged.

The liquid discharging head 21 is provided with a plurality of electrothermal conversion elements, and the electrothermal conversion elements are selectively driven on the basis of image information, so that ink is discharged from each nozzle orifice by the pressure of film boiling generated in ink by heat generation of the electrothermal conversion element.

The liquid discharging head 21 is retained in a state where it has been covered from the outer periphery side by a head frame 24 formed into a frame shape, and fixed to the head frame 24.

Between the paper feed section 100 and the liquid discharging block 200, a paper feed roller 13, a paper feed pinch roller 14, an edge sensor 15, a transport roller 16, and a pinch roller 17 are disposed in order from the paper feed section 100 side, as shown in FIG. 1. The paper feed roller 13 and the transport roller 16 are respectively rotated by driving motors (not shown).

An encoder (not shown) and an encoder sensor (not shown) are mounted on the transport roller 16. The transport speed of the recording sheet 1000 is detected by the encoder and the encoder sensor, and on the basis of the detected transport speed, the discharge timing of ink which is discharged from the liquid discharging head 21 is set so as to synchronize with the transport speed of the recording sheet 1000.

A transport roller 18 and a pinch roller 19 are disposed oh the opposite sides to the transport roller 16 and the pinch roller 17 across the liquid discharging block 200. The transport roller 18 is rotated by a driving motor (not shown).

The platen 300 is disposed below the liquid discharging block 200 so as to face the liquid discharging block 200 and has a function of retaining the recording sheet 1000. The upper surface of the platen 300 is formed as a retention face 31 which retains the recording sheet 100 which is transported.

The platen 300 is made so as to be able to move in a direction (up-and-down direction) away from or toward the liquid discharging surfaces 22a, 22a, . . . of the liquid discharging block 200 by a driving mechanism (not shown).

The suction section 400 has a function of generating suction power for suctioning and attaching the recording sheet 1000 to the platen 300. The suction section 400 includes a suction fan 41 and an air suction path 42.

If the suction fan 41 is rotated, air is suctioned from the platen 300 through the air suction path 42, so that the recording sheet 1000 is suctioned and attached to the platen 300, thereby being retained on the retention face 31. At this time, the recording sheet 1000 is suctioned and attached to the retention face 31 of the platen 300 by suction power which does not hinder transport.

The suction section 400 is moved in the up-and-down direction integrally with the platen 300.

The liquid detection unit 500 is disposed on the side of the platen 300 and has a function of detecting a discharge state of liquid from each liquid discharging nozzle (not shown) of the liquid discharging block 200.

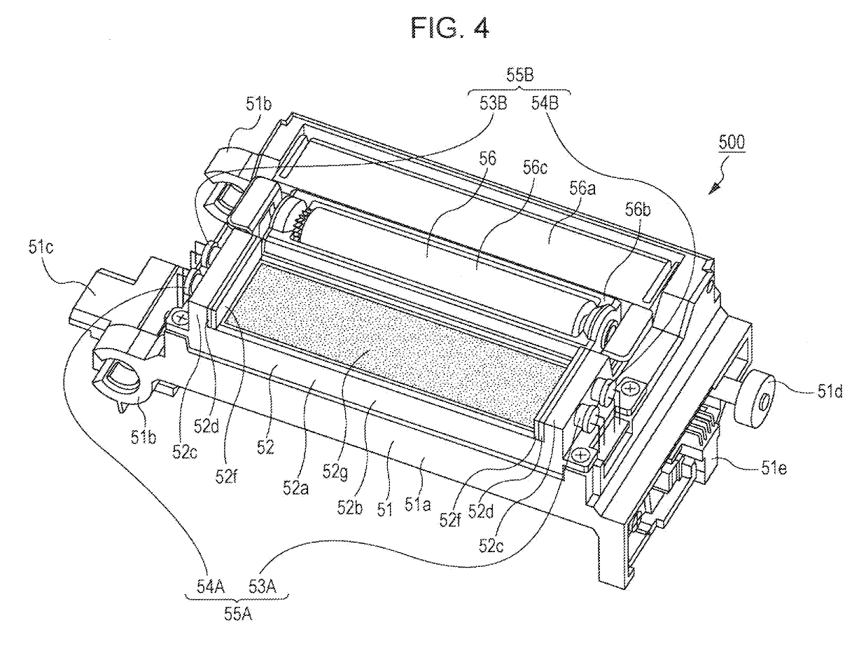

The necessary, respective sections of the liquid detection unit 500 are disposed on a support base 51 prefer to FIGS. 4 to 6).

The support base 51 has a support portion 51a and slide bearings 51b and 51b provided at one end portion in the sub-scanning direction of the support portion 51a, and the slide bearings 51b and 51b are located being spaced apart in the main scanning direction. On the support base 51, a belt support section 51c protruding outward is mounted below the slide bearing 51b. A slide roller 51d is rotatably supported on the other end portion in the sub-scanning direction of the support portion 51a. On the support base 51, an encoder sensor 51e is mounted at a position in the vicinity of the slide roller 51d.

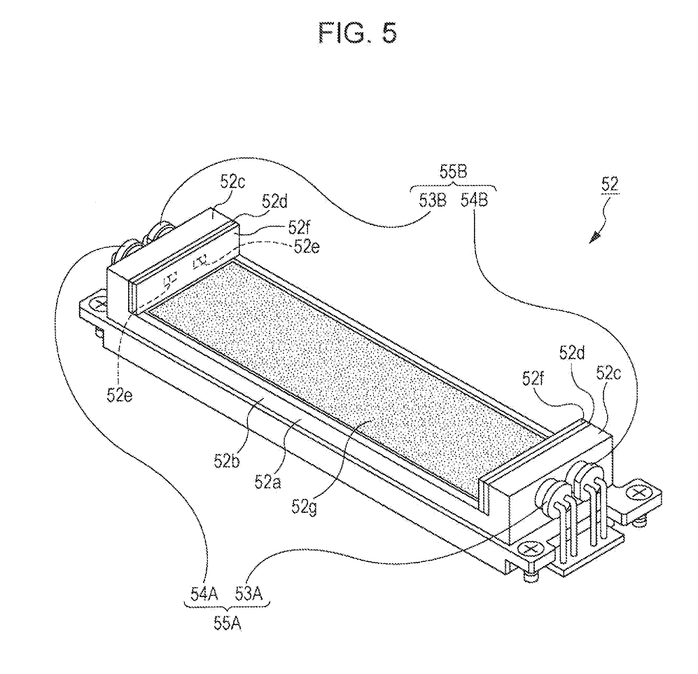

On the upper surface of the support portion 51a of the support base 51, a discharge detection section 52 is mounted, as shown in FIGS. 4 and 5, and the discharge detection section 52 is disposed at one end portion in the main scanning direction, for example, an end portion on the side facing the platen 300.

The discharge detection section 52 has a base for detection 52a and the base for detection 52a includes a base portion 52b formed into a box shape which extends in the sub-scanning direction and is opened upward and mounting projections 52c and 52c which respectively protrude upward from both end portions in the longitudinal direction of the base portion 52b. The base portion 52b functions as a tray of ink which is discharged from the liquid discharging nozzles of the liquid discharging head 21. In the mounting projections 52c and 52c, insertion disposition holes (not shown) are formed two for each mounting projection so as to be spaced apart in the main scanning direction. The insertion disposition holes are penetrated in the sub-scanning direction.

Opening plates 52d and 52d are respectively mounted on the surfaces on the opposed sides of the mounting projections 52c and 52c in the base for detection 52a. In each opening plate 52d, penetration holes 52e and 52e are respectively formed at positions facing the insertion disposition holes.

Contamination prevention plates 52f and 52f are respectively mounted on the surfaces on the opposed sides of the opening plates 52d and 52d and the contamination prevention plates 52f and 52f are formed by a material which transmits infrared light. By providing the contamination prevention plates 52f and 52f, contamination of the opening plates 52d and 52d by mist of ink (a liquid droplet) which may be possibly generated when ink that is discharged from the liquid discharging nozzles of the liquid discharging head 21 is dropped, or dust, is prevented.

Light emitting sections 53 and 53 (53A and 53B) and light sensing sections 54 and 54 (54A and 54B) are disposed at positions outside the mounting projections 52c and 52e in the base for detection 52a. At the positions on the outer surface side of the mounting projection 52c on one side, the light emitting section 53A and the light sensing section 54B are disposed adjacent to each other in order from one side in the main scanning direction, and at the positions on the outer surface side of the mounting projection 52c on the other side, the light sensing section 54A and the light emitting section 53B are disposed adjacent to each other in order from one side in the main scanning direction.

The light emitting sections 53A and 53B and the light sensing sections 54A and 54B are respectively partly inserted and disposed in the insertion disposition holes of the mounting projections 52c and 52c. A detection sensor 55A is constituted by the light emitting section 53A and the light sensing section 54A and a detection sensor 55B is constituted by the light emitting section 53B and the light sensing section 54B.

An absorber 52g is inserted and retained in the base portion 52b of the base for detection 52a. The absorber 52g has a function of absorbing ink before ink (a liquid droplet) becomes mist when ink that is discharged from the liquid discharging nozzle of the liquid discharging head 21 is dropped. By providing the absorber 52g, generation of false detection in the discharge detection section 52 due to the presence of mist is prevented and it is possible to prevent contamination of the internal structure of the liquid discharging apparatus 1 by mist.

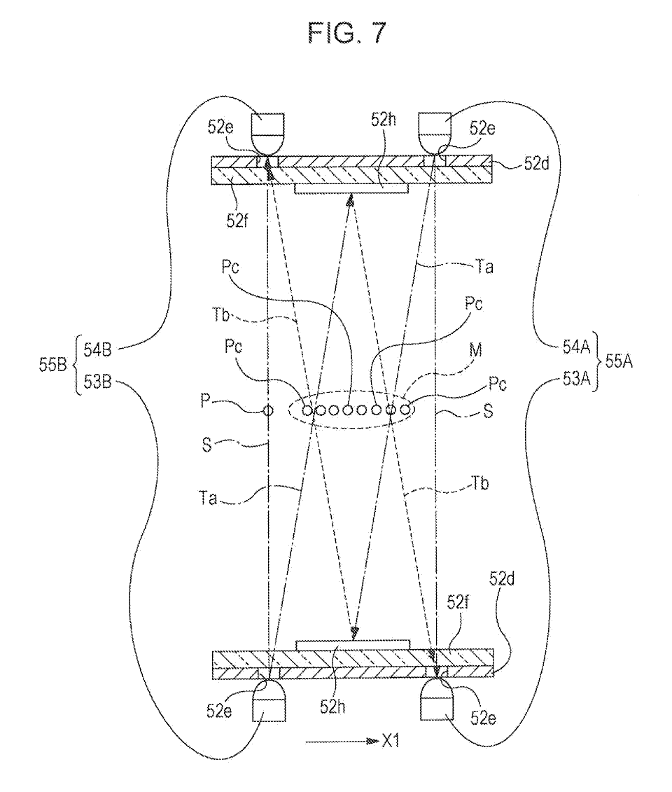

In the discharge detection section 52, detection lights (infrared lights) emitted from the light emitting sections 53A and 53B respectively pass through the penetration holes 52e and 52e of the opening plates 52d and 52d, penetrate the contamination prevention plates 52f and 52f, and then go straight ahead, as shown in FIG. 7. The lights (lights that progress in optical paths S and S shown in FIG. 7) which penetrate the contamination prevention plates 52f and 52f and then go straight ahead penetrate, the contamination prevention plates 52f and 52f again, penetrate the penetration holes 52e and 52e of the opening plates 52d and 52d, and are then received by the light sensing sections 54A and 54B respectively located being spaced in the sub-scanning direction from the light emitting sections 53A and 53B.

At this time, a discharge state of liquid from the liquid discharging nozzle is detected by a passage state in the luminous flux of the optical path S of an ink droplet (a liquid droplet) P that is discharged from the liquid discharging nozzle of the liquid discharging head 21. That is, if the ink droplet P passes through the luminous flux of the optical path S, a discharge state of liquid from the liquid discharging nozzle is detected to be good, and if the ink droplet P does not pass through the luminous flux of the optical path S, a discharge state of liquid from the liquid discharging nozzle is detected to be poor.

At the time of detection of the discharge state of liquid by the above-described discharge detection section 52, the liquid detection unit 500 is moved, in an X1 direction (refer to FIG. 7) in the main scanning direction from a detection start end in which detection is started up to a detection termination end in which detection is finished.

At this time, in the liquid discharging apparatus 1, preceding discharge that is a discharge operation of liquid (ink) from the liquid discharging nozzle which is present in a certain area M (refer to FIG. 7) located at a certain distance in the detection termination end side, from a detection position is performed ahead of detection by the liquid detection unit 500.

The preceding discharge is a discharge operation of trying to discharge ink from the nozzle orifice, and at the time of a discharge operation in the preceding discharge, from the liquid discharging nozzle in which abnormal discharge has not occurred, ink is normally discharged. However, from the liquid discharging nozzle in which abnormal discharge has occurred due to drying or the like of ink, there is a case where ink is not discharged. However, the discharge operation in the preceding discharge is continuously performed several times and during the plurality of discharge operations, there is a possibility that the liquid discharging nozzle in which abnormal discharge has occurred may be recovered to normal, so that ink is normally discharged.

That is, the discharge operation of liquid from the nozzle orifice which is present in a certain area located, at a certain distance in the detection termination end side from a detection position, which is performed ahead of detection by the liquid detection unit 500 at the time of movement of the liquid detection unit 500, corresponds to the discharge operation in the preceding discharge.

A certain area M is present, for example, between the optical paths S and S of the detection lights which, are emitted from the light emitting sections 53A and 53B and directed to the light sensing sections 54A and 54B. The detection lights which are emitted from the light emitting sections 53A and 53B are regulated in size of a luminous flux by the penetration holes 52e and 52e of the opening plates 52d and 52d. However, since light becomes larger, in the diameter of a luminous flux as light progresses and the diameter of each of the penetration holes 52e and 52e has a constant size, laterally-directed lights Ta and Ta (refer to FIG. 7) among the detection lights which are emitted from the light emitting sections 53A and 53B are also present.

Therefore, if the lights Ta and Ta are reflected by, for example, the contamination prevention plates 52f and 52f or the opening plates 52d and 52d, thereby becoming reflected lights Tb and Tb (refer to FIG. 7), there is possibility that ink droplets Pc, Pc, . . . in the preceding discharge may be present in the optical paths of the reflected lights Tb and Tb. If the ink droplets Pc, Pc, . . . in the preceding discharge are present in the optical paths of the reflected lights Tb and Tb, since the reflected lights Tb and Tb are lights which are emitted from the light emitting sections 53A and 53B and received by the light sensing sections 54A and 54B, there is concern that the ink droplets Pc, Pc, . . . other than the ink droplet P that becomes a detection target may be detected, causing false detection by the discharge detection section 52.

Therefore, in the liquid discharging apparatus 1, in order to prevent generation of false detection by the discharge detection section 52, it is desirable that antireflection portions 52h and 52h be respectively provided at position where the laterally-directed lights Ta and Ta among the detection lights which are emitted from the light emitting sections 53A and 53B are reflected (refer to FIG. 7). The antireflection portions 52h and 52h are provided at portions between the optical paths S and S among the opposed surfaces of the contamination prevention plates 52f and 52f. As the antireflection portions 52h and 52h, for example, antireflection plates may be used, and the antireflection portions 52h and 52h may be formed by applying sandblast or painting to the surfaces of the contamination prevention plates 52f and 52f.

Further, when ink is discharged from the liquid discharging nozzle of the liquid discharging head 21, as described above, there is a possibility that mist may be generated, and especially, in a case where mist is generated by ink in the preceding discharge, there is concern that, false detection of the discharge detection section 52 due to mist may occur. Further, there is also concern that contamination of the internal structure of the liquid discharging apparatus 1 may occur due to mist.

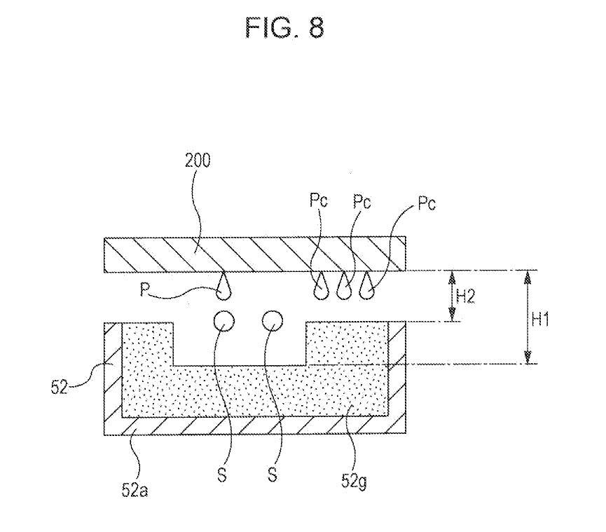

Therefore, in the liquid discharging apparatus 1, with respect to the distance of the space between the liquid discharging block 200 and the absorber 52g of the discharge detection section 52, as shown in FIG. 8, it is desirable that the distance of a space in which the optical paths S and S of the detection lights emitted from the light emitting sections 53 and 53 are present be set to be a distance H1 necessary not to shield the optical paths S and S and a distance H2 of a space in which the ink droplets Pc, Pc, . . . in the preceding discharge are dropped be set to be smaller than the distance H1. By setting such a relationship between the distances H1 and H2, before the ink droplets Pc, Pc, . . . in the preceding discharge become mist, the ink droplets are absorbed to the absorber 52g, so that false detection or contamination due to mist can be prevented.

On the support base 51, a cleaning section 56 is disposed on the side of the liquid detection section 52 (refer to FIG. 4).

The cleaning section 56 includes a turning lever 56a, a cleaner holder 56b mounted on the turning lever 56a, and a cleaner 56c held by the cleaner holder 56b in a rotatable state.

The turning lever 56a is made to be able to be turned in a direction in which the cleaner 56c is moved approximately in the up-and-down direction.

The cleaner holder 56b is formed into a box shape which extends in the sub-scanning direction and is opened upward, and made to be able to be mounted on and detached from the turning lever 56a.

The cleaner 56c is formed into a cylindrical shape and inserted into the cleaner holder 56b, thereby being supported in a rotatable state. The cleaner 56c has a function of being brought into contact with the liquid discharging surfaces 22a, 22a, . . . of the liquid discharging head 21, thereby cleaning the liquid discharging surfaces 22a, 22a, . . . . The contact of the cleaner 56c with the liquid discharging surfaces 22a, 22a, . . . is performed by approximately upward movement of the cleaner 56c by turning of the turning lever 56a when the liquid detection unit 500 is moved between the liquid discharging block 200 and the platen 300.

As described above, the cleaner holder 56b can be detached from the turning lever 56a. Therefore, in a case where attachment of ink to the cleaner 56c is noticeable, so that cleaning performance is deteriorated, replacement of the cleaner holder 56b with the cleaner 56c supported thereon can be easily performed by a user without touching the dirty cleaner 56c.

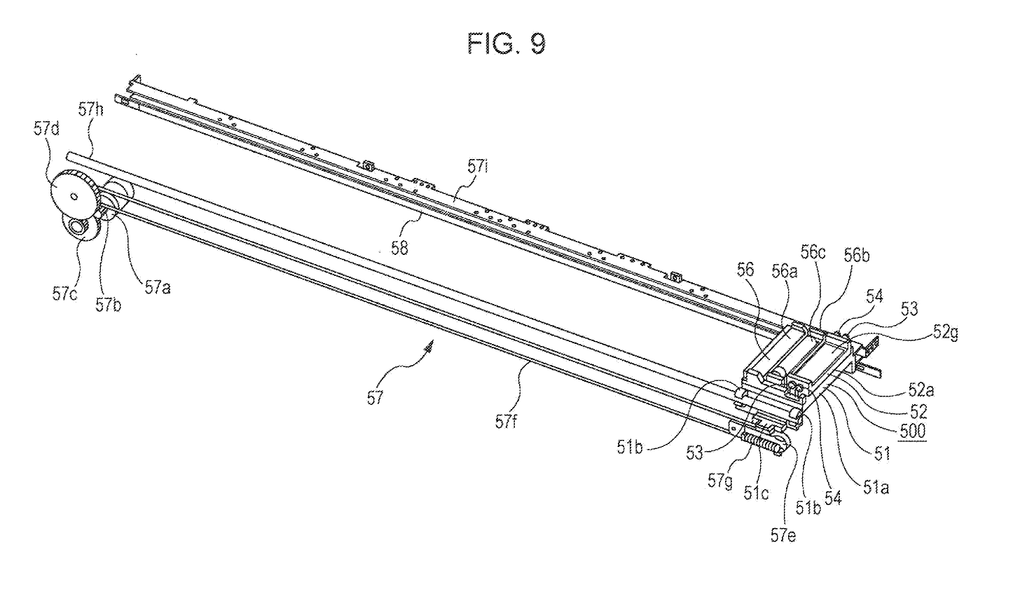

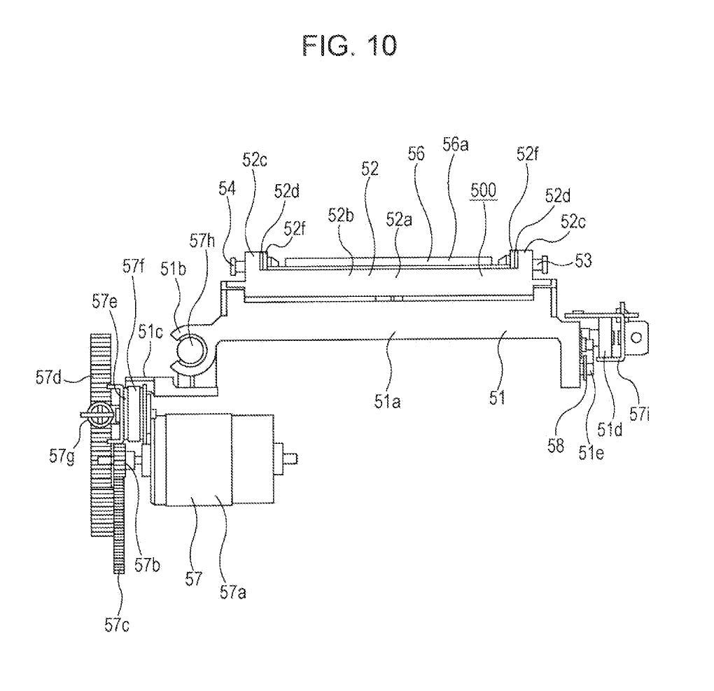

The liquid detection unit 500 is made so as to be able to be moved in the main scanning direction by a unit driving mechanism 57 (refer to FIGS. 9 and 10).

The unit driving mechanism 57 includes a motor for movement 57a, a motor gear 57b, a two-stage gear 57c, a gear pulley 57d, a pulley 57e, an endless belt 57f, a tensioner 57g, a guide shaft 57h, and a guide rail 57i.

The motor gear 57b is fixed to a motor shaft of the motor for movement 57a and the motor gear 57b, the two-stage gear 57c, and the gear pulley 57d are engaged in sequence. The gear pulley 57d and the pulley 57e are located being spaced apart in the main scanning direction and the endless belt 57f is wound between the two. Appropriate tension is imparted to the endless belt 57f by the tensioner 57g. A portion of the endless belt 57f is connected to the belt support section 51c provided at the support base 51 of the liquid detection unit 500.

The guide shaft 57h and the guide rail 57i are disposed in a state where they extend in the main scanning direction along the endless belt 57f in a parallel state.

An encoder 58 extending in the main scanning direction along the guide rail 57i is disposed in the vicinity of the guide rail 57i.

In the liquid detection unit 500, each of the guide bearings 51b and 51b is slidably supported on the guide shaft 57h, the slide roller 51d is rotatably engaged with the guide rail 57i, and the encoder sensor 51e is slidably engaged with the encoder 58.

In the unit driving mechanism 57, if the motor for movement 57a is rotated, the motor gear 57b, the two-stage gear 57c, and the gear pulley 57d are rotated, so that the endless belt 57f wound between the gear pulley 57d and the pulley 57e is driven in a direction according to the rotational direction of the motor for movement 57a. Therefore, the liquid detection unit 500 is moved in the main scanning direction in accordance with the rotational direction of the motor for movement 57a while being guided by the guide shaft 57h and the guide rail 57i.

At this time, the encoder 58 is read by the encoder sensor 51e, the timing of the discharge operation of ink from each nozzle orifice formed in the head chips 23, 23, . . . of the liquid discharging head 21 is set in accordance with the position of the discharge detection section 52 in the main scanning direction, and discharge information about all the liquid discharging nozzles of the liquid discharging head 21 is detected.

The capping section 600 has a function of improving the hermetic sealing properties of a space which is formed between the liquid discharging surfaces 22a, 22a, . . . of the liquid discharging block 200 and the platen 300, thereby preventing drying or the like of ink which is discharged from the liquid discharging block 200. The capping section 600 is made to be able to move in the up-and-down direction.

The moisturizer supply section 700 has a function of supplying moisturizer in order to make the space between the liquid discharging surfaces 22a, 22a, . . . of the liquid discharging block 200 and the platen 300 hermetically sealed by the capping section 600 be in a wet state.

The moisturizer supply section 700 includes a moisturizer storage section 71 in which the moisturizer is stored, a moisturizer supply tube 72 which becomes a moisturizer supply path from the moisturizer storage section 71 up to the platen 300, and a moisturizer supply pump 73 disposed at an intermediate portion of the moisturizer supply tube 72.

The moisturizer stored in the moisturizer storage section 71 is sent from the moisturizer supply tube 72 to a moisturizer absorption section (not shown) provided inside the platen 300 by the driving of the moisturizer supply pump 73, so that the space between the liquid discharging surfaces 22a, 22a, . . . and the platen 300 enters into a wet state.

The cutter 800 has a function of cutting the rolled paper as the recording sheet 1000 and the paper discharge section 900 is a section to which the recording sheet 1000 with an image recorded thereon by the liquid discharging block 200 is discharged.

Transport Operation of Recording Sheet in Liquid Discharging Apparatus

Next, an operation from paper feed up to paper discharge of the recording sheet 1000 in the liquid discharging apparatus 1 will be described (refer to FIG. 1).

The recording sheet 1000 is transported in a transport path A from the paper feed section 100 up to the paper discharge section 900.

The rolled paper or the cut paper is fed from the rolled paper feed tray 11 with the rolled paper as the recording sheet 1000 loaded therein or the cut paper manual feed tray 12 with the cut paper as the recording sheet 1000 loaded therein by the paper feed roller 13 and the paper feed pinch roller 14.

The recording sheet 1000 that is transported is detected by the edge sensor 15 and further transported toward between the liquid discharging block 200 and the platen 300 by the transport roller 16 and the pinch roller 17.

When the recording sheet 1000 is transported by the transport roller 16 and the pinch roller 17, the capping section 600 is operated, so that the transport path A between the liquid discharging block 200 and the platen 300 is opened, and the suction fan 41 of the suction section 400 is rotated. The recording sheet 1000 is suctioned and attached to and retained on the retention face 31 of the platen 300 by the suction power of the suction section 400.

If a total transport amount of a transport amount by the paper feed roller 13 from the point of time when the edge sensor 15 has detected the leading end of the recording sheet 1000 and a transport amount by the transport roller 16 reaches a predetermined value, a recording operation on the recording sheet 1000 by the liquid discharging block 200 is started.

If the recording sheet 1000 passes the transport roller 16 and the pinch roller 17, the recording sheet 1000 is further transported toward the paper discharge section 900 by the transport roller 18 which is rotated in synchronization with the transport roller 16, and the pinch roller 19.

If recording on the recording sheet 1000 is finished, the operation of the suction fan 41 is stopped and the recording sheet 1000 is transported up to the paper discharge section 900. In the case of the cut paper, the recording sheet 1000 is transported up to the paper discharge section 900 without an operation of the cutter 800, and in the case of the rolled paper, the recording sheet 1000 is cut by the cutter 800 and then transported up to the paper discharge section 900.

If the transport operation of the recording sheet 1000 is finished, the capping section 600 is operated again, so that the space between the liquid discharging block 200 and the platen 300 is blocked and hermetically sealed.

Detection Operation of Discharge State by Discharge Detection Section of Liquid Detection Unit

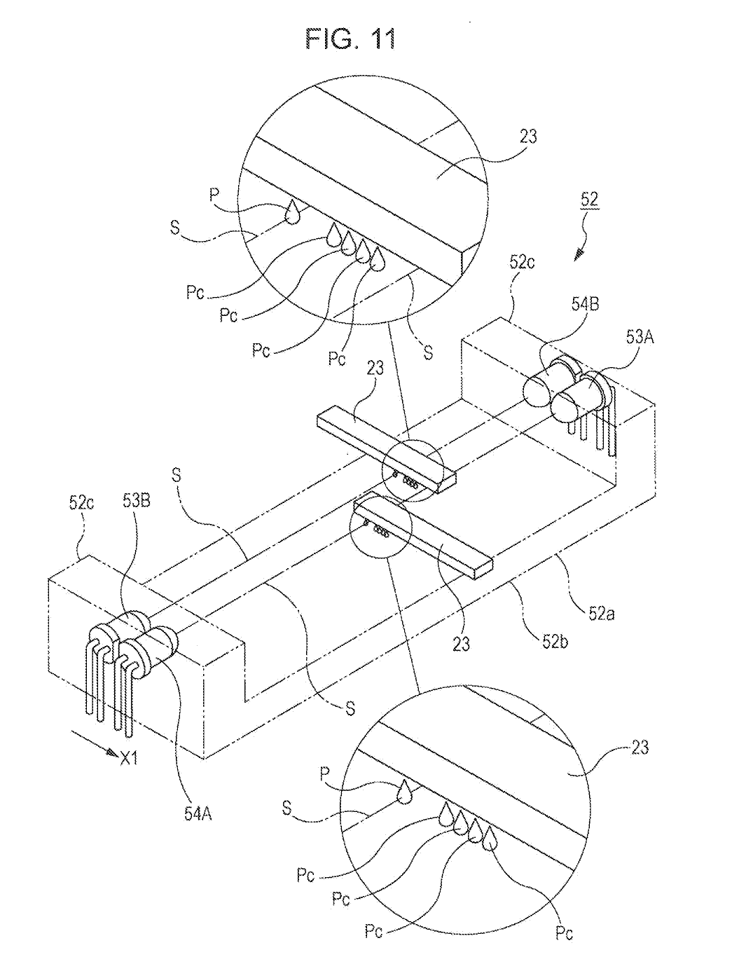

Next, a detection operation of a discharge state by the discharge detection section 52 provided at the liquid detection unit 500 will be described (refer to FIGS. 11 to 22). The detection operation is performed when the discharge detection section 52 is moved from the detection start end in which detection is started, up to the detection termination end in which discharge is finished. At this time, as described above, preceding discharge that is the discharge operation of liquid from the nozzle orifice that is present in a certain area located at a certain distance in the detection termination end side from a detection position is performed ahead of the discharge operation of liquid from the nozzle orifice of the liquid discharging nozzle that becomes a detection target.

The preceding discharge is an ink discharge operation which is performed several times in the liquid discharge nozzle present in the above-mentioned certain area, and by performing the preceding discharge, the discharge state of the liquid discharging nozzle which is in a discharge defect state is recovered or drying of ink present in the liquid discharging nozzle is prevented.

Further, the preceding discharge is sequentially performed, at the time of movement in the main scanning direction of the liquid detection unit 500, at a predetermined timing in the nozzle orifices present in a certain area in the movement direction, and for example, discharge operations of ink are performed approximately at the same time in a certain number of adjacent liquid discharging nozzles, each time proceeding in sequence.

The above-mentioned detection position where, a discharge state of ink is detected is a position on each of the optical paths S and S (refer to FIGS. 7, 11, and 12) in which the detection lights emitted from the light emitting sections 53 and 53 of the discharge detection section 52 go straight toward the light sensing sections 54 and 54.

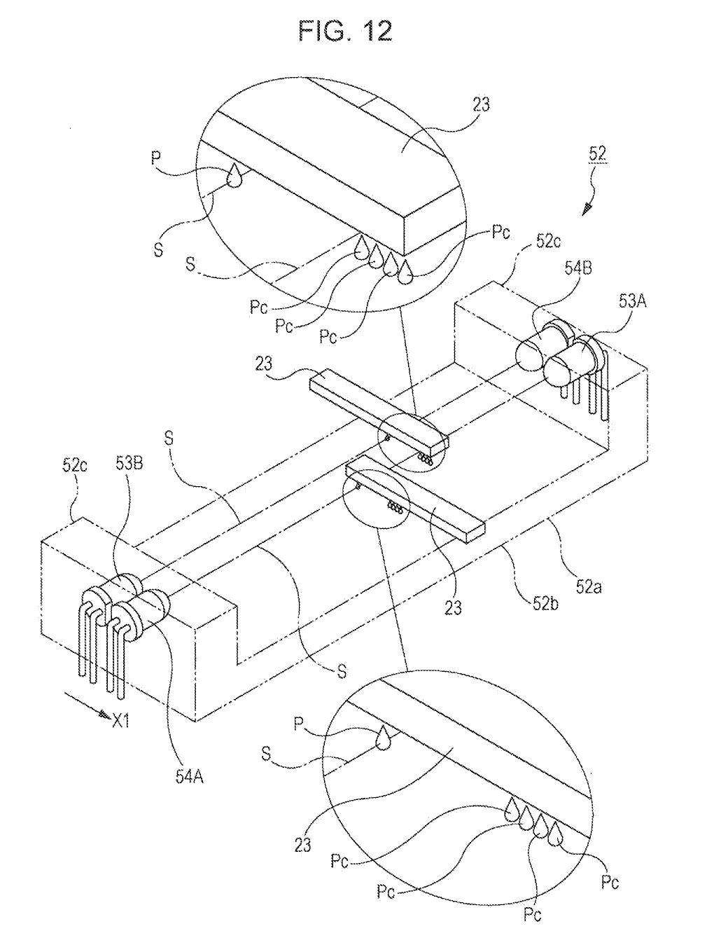

Further, a position where the preceding discharge is performed is out of a detection range of the ink droplet P that becomes a detection target and is, for example, a position between the optical paths S and S or a position located further at the movement direction X1 side than the optical path S present on the movement direction X1 side (refer to FIGS. 11 and 12). With respect to the position located further at the movement direction X1 side than the optical path S present on the movement direction X1 side, it is possible to select either a position (refer to FIG. 11) close to the optical path S or a position (refer to FIG. 12) away from the optical path S.

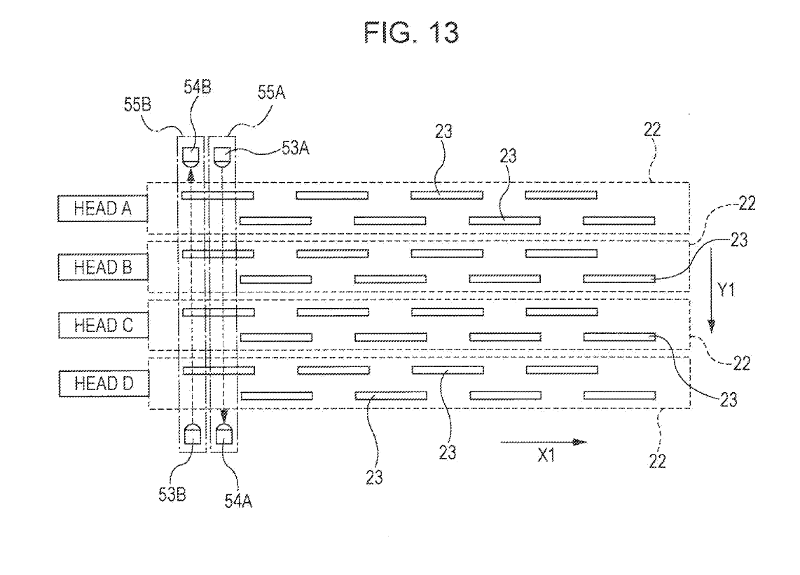

A specific example of the detection operation will be described below (refer to FIG. 13). In the following, as an example, the detection operation in a case where four module heads 22, 22, . . . (a Head A to a Head D) are disposed is illustrated. The head A to the head D are the liquid discharging heads which respectively discharge ink of different colors.

Each module head 22 has the head chips 23, 23, . . . arranged in a zigzag manner and the head chips 23, 23, . . . are distinguished into the odd-numbered chips (the first, the third, the fifth, . . . ) and the even-numbered chips (the second, the fourth, the sixth, . . . ) in order counting from the detection start end side. In the liquid, discharging apparatus 1, for example, the discharge states of ink regarding the liquid discharging nozzles present in the even-numbered chips are detected by the detection sensor 55A which is constituted by the light emitting section 53A and the light sensing section 54A, and the discharge states of ink regarding the liquid discharging nozzles present in the odd-numbered chips are detected by the detection, sensor 55B which is constituted by the light emitting section 53B and the light sensing section 54B.

Further, in the liquid discharging apparatus 1, a configuration can also be made such that the discharge states of ink regarding all the liquid discharging nozzles present in each head chip are continuously detected twice by the detection sensor 55A and the detection sensor 55B without distinguishing the head chips into the odd-numbered chips and the even-numbered chips.

The detection operation is performed when the liquid detection unit 500 is moved in the main scanning direction X1 perpendicular to the sub-scanning direction (the transport direction of the recording sheet 1000) Y1 (refer to FIG. 13).

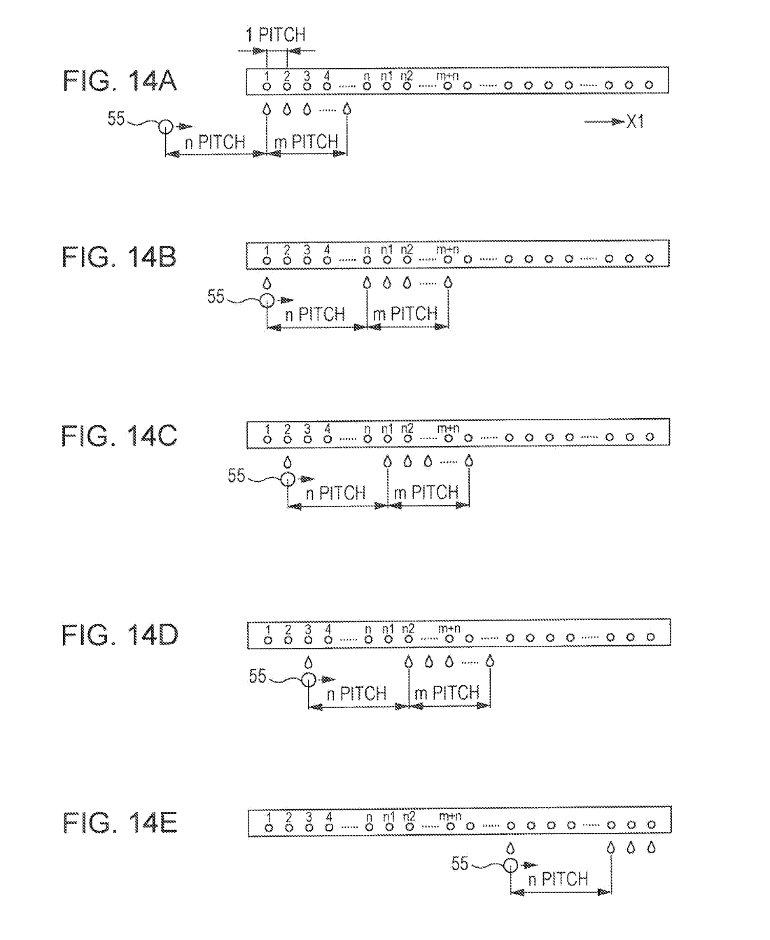

In FIGS. 14A to 14E, 1, 2, 3, . . . , n, n1, n2, . . . , m+n, . . . respectively denote the liquid discharging nozzles numbered for convenience and the distance between adjacent liquid discharging nozzles is shown as one pitch. In addition, for simplicity of explanation, the explanations of FIGS. 14A to 14E are performed assuming that, the detection of a discharge state regarding the liquid discharging nozzle is performed by the detection sensor 55 on one side.

Before the start of movement in the X1 direction of the detection sensor 55, at the detection start end, the detection sensor 55 is located being spaced by n pitch from the liquid discharging nozzle 1 (refer to FIG. 14A). At the time of the start of movement of the detection sensor 55, at the same time, the preceding discharge is performed in the liquid discharging nozzles present by m pitch from the liquid discharging nozzle 1 to the liquid discharging nozzle m.

Before the start of movement in the X1 direction of the detection sensor 55, at the detection start end, the detection sensor 55 is located being spaced by n pitch from the liquid discharging nozzle 1 (refer to FIG. 14A). At the time of the start of movement of the detection sensor 55, at the same time, the preceding discharge is performed in each liquid discharging nozzle present by m pitch from the liquid discharging nozzle 1 to the liquid discharging nozzle m.

If the detection sensor 55 is moved to a vicinity directly below the liquid discharging nozzle 1, the discharge operation of ink is performed in the liquid discharging nozzle 1 and the detection of a discharge state regarding the liquid discharging nozzle 1 by the detection sensor 55 is performed (refer to FIG. 14B). When the detection of a discharge state regarding the liquid discharging nozzle 1 is performed, the preceding discharge is performed in each liquid discharging nozzle present by m pitch from the liquid discharging nozzle n to the detection termination end side.

Subsequently, if the detection sensor 55 is moved by one pitch from the vicinity directly below the liquid discharging nozzle 1, thereby being moved to a vicinity directly below the liquid discharging nozzle 2, the discharge operation of ink is performed in the liquid discharging nozzle 2 and the detection of a discharge state regarding the liquid discharging nozzle 2 by the detection sensor 55 is performed (refer to FIG. 14C). When the detection of a discharge state regarding the liquid discharging nozzle 2 is performed, the preceding discharge is performed in each liquid discharging nozzle present by m pitch from the liquid discharging nozzle n1 to the detection termination end side.

Continuously, if the detection sensor 55 is moved by one pitch from the vicinity directly below the liquid discharging nozzle 2, thereby being moved to a vicinity directly below the liquid discharging nozzle 3, the discharge operation of ink is performed in the liquid discharging nozzle 3 and the detection of a discharge state regarding the liquid discharging nozzle 3 by the detection sensor 55 is performed (refer to FIG. 14D). When the detection of a discharge state regarding the liquid discharging nozzle 3 is performed, the preceding discharge is performed in each liquid discharging nozzle present by m pitch from the liquid discharging nozzle n2 to the detection termination end side.

Since, then, in sequence, the detection of a discharge state regarding each liquid discharging nozzle by the detection sensor 55 is performed (refer to FIG. 14E). Since just before detection termination, the number of liquid discharging nozzles present on the detection termination end side with the liquid discharging nozzle spaced by n pitch from the liquid discharging nozzle that becomes a detection target as a standard is reduced, the preceding discharge is performed only in the liquid discharging nozzles present on the detection termination end side with the liquid discharging nozzle spaced by n pitch from the liquid discharging nozzle that becomes a detection target as a standard.

Detection by the detection sensor 55 on the liquid discharging nozzle which is located on the most detection termination end side is performed and the detection sensor 55 is moved up to, the detection termination end, whereby the detection operation of a discharge state regarding the liquid discharging nozzle is finished.

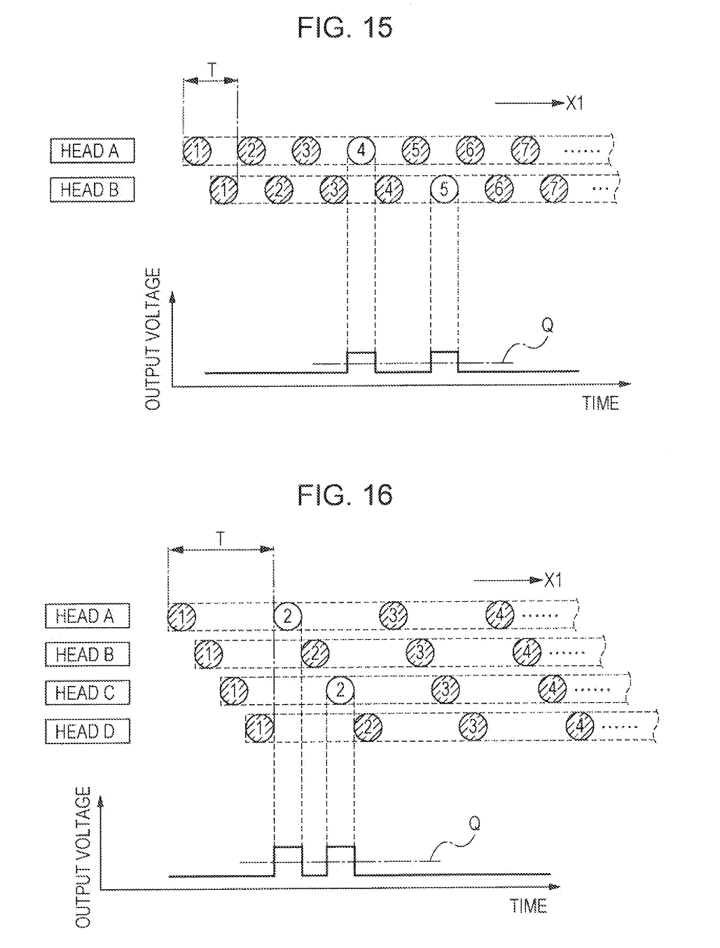

Next, the detection operation of a discharge state by the discharge detection section 52 regarding a plurality of module, heads 22, 22, . . . of the liquid discharging head 21 will be described (refer to FIGS. 15 to 22D).

First, as an example, in a case where two module heads 22 and 22 (the head A and the head B) are disposed, the detection operation when the discharge operations in the liquid discharging nozzles of the respective module heads 22 and 22 are intermittently performed is illustrated (refer to FIG. 15). The head A and the head B are, the liquid discharging heads which respectively discharge ink of different colors.

In FIG. 15, 1, 2, 3, . . . denote the liquid discharging nozzles disposed in order from the detection start end side, and a state where ink has been discharged, by the discharge operation is shown with hatching, and a state where ink has not been discharged even by the discharge operation is shown without hatching. In addition, for simplicity of explanation, the explanation of FIG. 15 is performed assuming that the detection of a discharge state regarding the liquid discharging nozzle is performed by the detection sensor 55 on one side.

The discharge operation of ink is intermittently performed every constant period in order in the liquid discharging nozzles 1, 2, 3, . . . of the head A. In the liquid discharging nozzles 1, 2, 3, . . . of the head B, the discharge operation of ink is intermittently performed every constant period when the discharge operation of ink is not performed in the liquid discharging nozzle of the head A.

If the movement period of one dot of the liquid detection unit 500 is set to be a reference discharge period T, in the reference discharge period T, the discharge operations are performed in two liquid discharging nozzles.

An example shown in FIG. 15 shows a state where discharge of ink from the liquid discharging nozzle 4 of the head A and the liquid discharging nozzle 5, of the head B has not been performed. When discharge of ink has not been performed, since ink is not present in the luminous flux of the optical path S of the detection light from the light emitting section 53 toward the light sensing section 54, the output voltage at the time of detection rises. At this time, threshold voltage Q is set and in a case where the output voltage higher than the threshold voltage Q is measured, a discharge defect of the liquid discharging nozzle is detected.

Specifying the liquid discharging nozzle in which a discharge defect has been detected is performed by using whether or not the output voltage higher than the threshold voltage Q is measured and measurement of a time (phase) together.

By adopting such a method, it is possible to simultaneously detect the discharge states of ink with respect to the respective nozzles of the two module heads 22 and 22 by single movement of the liquid detection unit 500 from the detection start end up to the detection termination end.

Next, as an example, in a case where four module heads 22, 22, . . . (the head A to the head D) are disposed, the detection operation when the discharge operations in the liquid discharging nozzles of the respective module heads 22, 22, . . . are intermittently performed is illustrated (refer to FIG. 16). The head A to the head D are the liquid discharging heads which respectively discharge ink of different colors.

In FIG. 16, 1, 2, 3, . . . denote the liquid discharging nozzles disposed in order from the detection start end side, and a state where ink has been discharged by the discharge operation is shown with hatching, and a state where ink has not been discharged even by the discharge operation is shown without hatching. In addition, for simplicity of explanation, the explanation of FIG. 16 is performed assuming that the detection of a discharge state regarding the liquid discharging nozzle is performed by the detection sensor 55 on one side.

The ink discharge operation is intermittently performed every same constant period in order in the liquid discharging nozzles 1, 2, 3, . . . of the respective heads A, B, C, and D. The start, of the discharge operation of ink of the head B is performed a quarter of a period late with respect to the start of the discharge operation of ink of the head A. The start of the discharge operation of ink of the head C is performed a quarter of a period late with respect to the start of the discharge operation of ink of the head B. The start of the discharge operation of ink of the head D is performed a quarter of a period late with respect to the start of the discharge operation of ink of the head C.

If the movement period of one dot of the liquid, detection unit 500 is set to be the reference discharge period T, in the reference discharge period T, the discharge operations are performed in four liquid discharging nozzles.

An example shown in FIG. 16 shows a state where discharge of ink from the liquid discharging nozzle 2 of the head A and the liquid discharging nozzle 2 of the head C has not been performed. When discharge of ink has not been performed, since ink is not present in the luminous flux of the optical path S of the detection light from the light emitting section 53 toward the light sensing section 54, the output voltage at the time of detection rises. At this time, the threshold voltage Q is set and in a case where the output voltage higher than the threshold voltage Q is measured, a discharge defect of the liquid discharging nozzle is detected.

Specifying the liquid discharging nozzle in which a discharge defect has been detected is performed by using whether or not the output voltage higher than the threshold voltage Q is measured and measurement of a time (phase) together.

By adopting such a method, it is possible to simultaneously detect the discharge states of ink with respect to the respective, nozzles of the four module heads 22, 22, . . . by single movement of the liquid detection unit 500 from the detection start end up to the detection termination end.

In addition, in FIGS. 15 and 16, as an example, the detection operations in cases where two module heads 22 and 22 and four module heads 22, 22, . . . are disposed are shown. However, even in a case where three or five or more module heads 22, 22, . . . are disposed, it is possible to perform the same detection operation as the above.

By adopting such a method, it is possible to simultaneously detect the discharge states of ink with respect to the respective nozzles of three or five or more of the module heads 22, 22, . . . by single movement of the liquid detection unit 500 from the detection start end up to the detection termination end.

Further, in the above examples, a configuration is made such that the discharge operation of ink from each liquid discharging nozzle of the module heads 22, 22, . . . is intermittently performed once in order and the discharge operation of ink from each liquid discharging nozzle of the module heads 22, 22, . . . is performed when the discharge operation of ink from each liquid discharging nozzle of the other module heads 22, 22, . . . is not performed.

Therefore, the fewer number of times of the discharge operations of ink from each liquid discharging nozzle of the module heads 22, 22, . . . is necessary, so that it is possible to attain simplification of the detection operation, and also the amount of discharged ink is small, so that it is possible to attain a reduction in the amount of consumption of ink.

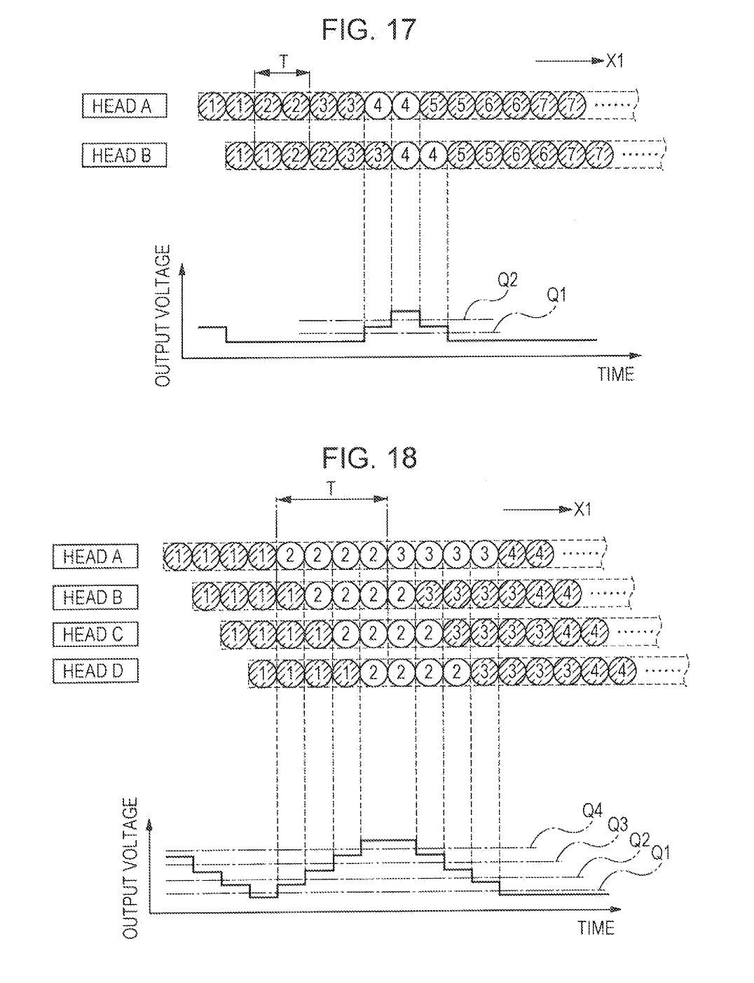

Next, as an example, in a case, where two module heads 22 and 22 (the head A and the head B) are disposed, the detection operation when the discharge operations in the liquid discharging nozzles of the respective module heads 22 and 22 are continuously performed is illustrated (refer to FIG. 17). The head A and the head B are the liquid discharging heads which respectively discharge ink of different colors.

In FIG. 17, 1, 2, 3, . . . denote the liquid discharging nozzles disposed in order from the detection start end side, and a state where ink has been discharged by the discharge operation is shown with hatching, and a state where ink has not been discharged even by the discharge, operation is shown without hatching. In addition, for simplicity of explanation, the explanation of FIG. 17 is performed assuming that the detection of a discharge state regarding the liquid discharging nozzle is performed by the detection sensor 55 on one side.

The discharge operation of ink is continuously performed twice every constant period in order in the liquid discharging nozzles 1, 2, 3, . . . of the head A. In the liquid discharging nozzles 1, 2, 3, . . . of the head B, the discharge operation is started at the same time when the second discharge operation of ink is performed in the liquid discharging nozzle of the head A, and thereafter, the discharge operation of ink is continuously performed twice every same constant period at the same time as each discharge operation of the head A.

If the movement period of one dot of the liquid detection unit 500 is set to be the reference discharge period T, except for the time of the start of the discharge operation and the time of the end of the discharge operation, in the reference discharge period T, the discharge operations are performed in four liquid discharging nozzles.

An example shown in FIG. 17 shows, a state where discharge of ink from the liquid discharging nozzle 4 of the head A and the liquid discharging nozzle 4 of the head B has not been performed. When discharge of ink has not been performed, since ink is not present in the luminous flux of the optical path S of the detection light from the light emitting section 53 toward the light sensing section 54, the output voltage at the time of detection rises. At this time, first threshold voltage Q1 and second threshold voltage Q2 are set and a discharge defect of the liquid discharging nozzle is detected.

Specifying the liquid discharging nozzle in which a discharge defect has been detected is performed by using whether or not the output voltage higher than the first threshold voltage Q1 or the second threshold voltage Q2 is measured and measurement of a time (phase) together.

By adopting such a method, it is possible to simultaneously detect the discharge states of ink with respect to the respective nozzles of the two module heads 22 and 22 by single movement of the liquid detection unit 500 from the detection start end up to the detection termination end.

Next, as an example, in a case where four module heads 22, 22, . . . (the head A to the head D) are disposed, the detection operation when the discharge operations in the liquid discharging nozzles of the respective module heads 22, 22, . . . are continuously performed, is illustrated (refer to FIG. 18). The head A to the head D are the liquid discharging heads which respectively discharge ink of different colors.

In FIG. 18, 1, 2, 3, . . . denote the liquid discharging nozzles disposed in order from the detection start end side, and a state where ink has been discharged by the discharge operation is shown with hatching, and a state where ink has not been discharged even by the discharge, operation is shown without hatching. In addition, for simplicity of explanation, the explanation of FIG. 18 is performed assuming that the detection of a discharge state regarding the liquid, discharging nozzle is performed by the detection sensor 55 on one side.

The discharge operation of ink is continuously performed four times every constant period in order in the liquid discharging nozzles 1, 2, 3, . . . of the head A. In the liquid discharging nozzles 1, 2, 3, . . . of the head B, the discharge operation is started at the same time when the second discharge operation of ink is performed in the liquid discharging nozzle of the head A, and thereafter, the discharge operation of ink is continuously performed four times every same constant period at the same time as each discharge operation of the head A. In the liquid discharging nozzles 1, 2, 3, . . . of the head C, the discharge operation is started at the same time when the second discharge operation of ink is performed in the liquid discharging nozzle of the head B, and thereafter, the discharge operation of ink is continuously performed four times every same constant, period at the same time as each discharge operation of the heads A and B. In the liquid discharging nozzles 1, 2, 3, . . . of the head D, the discharge operation is started at the same time when the second discharge operation of ink is performed in the liquid discharging nozzle of the head C, and thereafter, the discharge operation of ink is continuously performed four times every same constant period at the same time as each discharge operation of the heads A, B, and C.

If the movement period of one dot of the liquid detection unit 500 is set to be the reference discharge period T, except for the time of the start of the discharge operation and the time of the end of the discharge operation, in the reference discharge period T, the discharge operations are performed in sixteen liquid discharging nozzles.

An example shown in FIG. 18 shows a state where discharge of ink from the liquid discharging nozzles 2 and 3 of the head A, the liquid discharging nozzle 2 of, the head B, the liquid discharging nozzle 2 of the head C, and the liquid discharging nozzle 2 of the head D has not been performed. When discharge of ink has not been performed, since ink is not present in the luminous flux of the optical path S of the detection light from the light emitting section 53 toward the light sensing section 54, the output voltage at the time of detection rises. At this time, the first, threshold voltage Q1, the second threshold voltage Q2, third threshold voltage Q3, and fourth threshold voltage Q4 are set and a discharge defect of the liquid discharging nozzle is detected.

Specifying the liquid discharging nozzle in which a discharge defect has been detected is performed by using whether or not the output voltage higher than the first threshold voltage Q1, the second threshold voltage Q2, the third threshold voltage Q3, or the fourth threshold voltage Q4 is measured and measurement of a time (phase) together.

By adopting such a method, it is possible to simultaneously detect the discharge states of ink with respect to the respective nozzles of the four module heads 22, 22, . . . by single movement of the liquid detection unit 500 from the detection start end up to the detection termination end.

In addition, in FIGS. 17 and 18, as an example, the detection operations in cases where two module heads 22 and 22 and four module heads 22, 22, . . . are disposed are shown. However, even in a case where three or five or more module heads 22, 22, . . . are disposed, it is possible to perform the same detection operation as the above.

That is, when the number of module heads 22, 22, . . . is set to be n, the discharge operation of ink from each liquid discharging nozzle of the respective module heads 22, 22, . . . is performed n times in order and the start of the discharge operations of ink of the respective module heads 22, 22, . . . disposed adjacently are performed being delayed once in order, whereby detection is performed.

In this manner, since the discharge operation of ink from the liquid discharging nozzle is performed n times, there is also a possibility that the liquid discharging nozzle having a discharge defect may return to normal while n times of discharge operations are performed, so that it is possible to reduce the number of liquid discharging nozzles having a discharge defect.

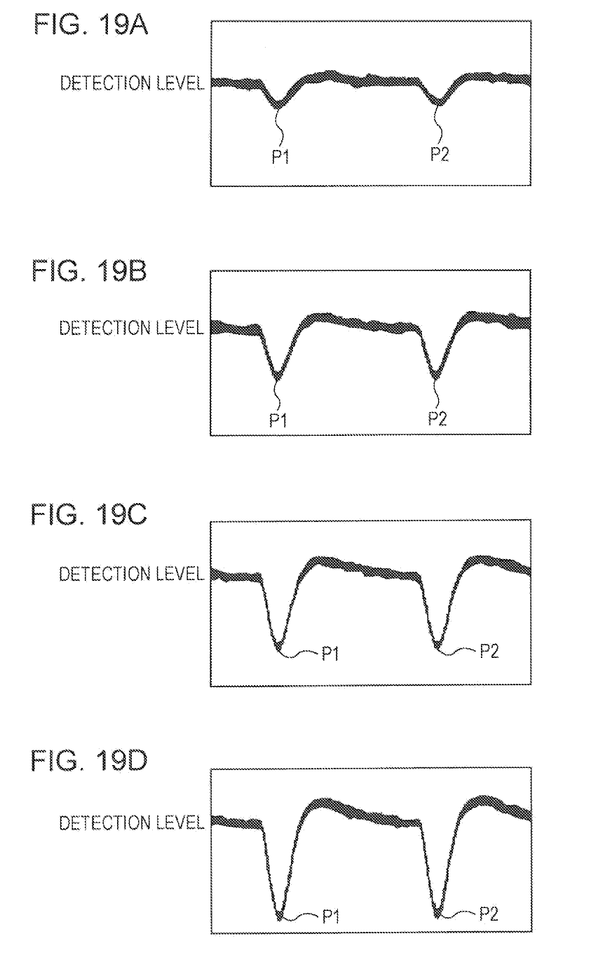

FIGS. 19A to 19D are diagrams illustrating waveforms of detection levels at the time of detection by the discharge detection section 52.

FIG. 19A illustrates a state where the discharge operation is performed in one liquid discharging nozzle, FIG. 19B illustrates a state where, the discharge operations are performed in two liquid discharging nozzles, FIG. 19C illustrates a state, where the discharge operations, are performed in three liquid discharging nozzles, and FIG. 19D illustrates a state where the discharge operations are performed in four liquid discharging nozzles.

That is, P1 and P2 in FIG. 19A are states where one ink droplet (liquid droplet) is present in the luminous flux of the optical path S, P1 and P2 in FIG. 19B are states where two liquid droplets are present being spaced apart in the sub-scanning direction in the luminous flux of the optical path S, P1 and P2 in FIG. 19C are states where three liquid droplets are present being spaced apart in the sub-scanning direction in the luminous flux of the optical path S, and P1 and P2 in FIG. 19D are states where four liquid droplets are present being spaced apart in the sub-scanning direction in the luminous flux of the optical path S.

P1 and P2 in which detection levels are changed are present in each of FIGS. 19A to 19D. However, it can be understood that a major change appears in accordance with an increase in the number of liquid droplets which are present.

Therefore, the S/N ratio of a detection signal becomes large by performing detection on a plurality of liquid discharging nozzles (two liquid discharging nozzles in FIG. 17 and four liquid discharging nozzles in FIG. 18) shown in FIGS. 17 and 18 by the discharge detection section 52, so that it is possible to attain improvement in detection accuracy.

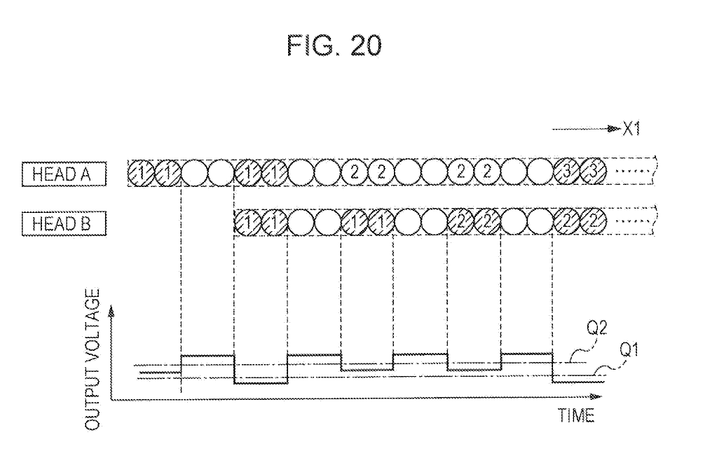

Next, as an example, in a case where two module heads 22 and 22 (the head A and the head B) are disposed, the detection operation when the discharge operations in the liquid discharging nozzles of the respective module heads 22 and 22 are intermittently performed at a double speed is illustrated (refer to FIG. 20). The heads A and B are the liquid discharging heads which respectively discharge ink of different colors.

In FIG. 20, 1, 2, 3, . . . denote the liquid discharging nozzles disposed in order from the detection start end side, and a state where ink has been discharged by the discharge operation is shown by hatching, and a state where ink has not been discharged even by the discharge operation is shown without hatching. In addition, for simplicity of explanation, the explanation of FIG. 20 is performed assuming that the detection of a discharge state regarding the liquid discharging nozzle is performed by the detection sensor 55 on one side.

The discharge operation of ink is intermittently performed twice every constant period in order in the liquid discharging nozzles 1, 2, 3, . . . of the head A. In the liquid discharging nozzles 1, 2, 3, . . . of the head B, the discharge operation of ink is intermittently performed twice every same constant period, at the same time when the third discharge operation of ink is performed in the liquid discharging nozzle of the head A. Therefore, since the intermittent discharge operations of ink are simultaneously performed in the two heads A and B, a period in which the discharge operation is not performed occurs intermittently. Further, twice discharge operations are performed at double speed of the discharge operations of FIGS. 15 to 18.

An example shown in FIG. 20 shows a state where discharge of ink from the liquid discharging nozzle 2 of the head A has not been performed. When discharge of ink has not been performed, since ink is not present in the luminous flux of the optical path S of the detection light from the light emitting section 53 toward the light sensing section 54, the output voltage at the time of detection rises. At this time, the first threshold voltage Q1 and the second threshold voltage Q2 are set and in a case where the output voltage higher than the first threshold voltage Q1 or the second threshold voltage Q2 is measured, a discharge defect of the liquid discharging nozzle is detected.

Specifying the liquid discharging nozzle in which a discharge defect has been detected is performed by using whether or not the output voltage higher than the first threshold voltage Q1 or the second threshold voltage Q2 is measured and measurement of a time (phase) together.

By adopting such a method, it is possible to simultaneously detect the discharge states of ink with respect to the respective nozzles of the two module heads 22 and 22 by single movement of the liquid detection unit 500 from the detection start end up to the detection termination end.

Further, as described above, since in the discharge direction, a plurality of ink droplets are present in the luminous flux of the optical path S of the detection light by intermittently performing the discharge operation of ink at a double speed, the S/n ratio of a detection signal becomes large, so that it is possible to attain improvement in detection accuracy.

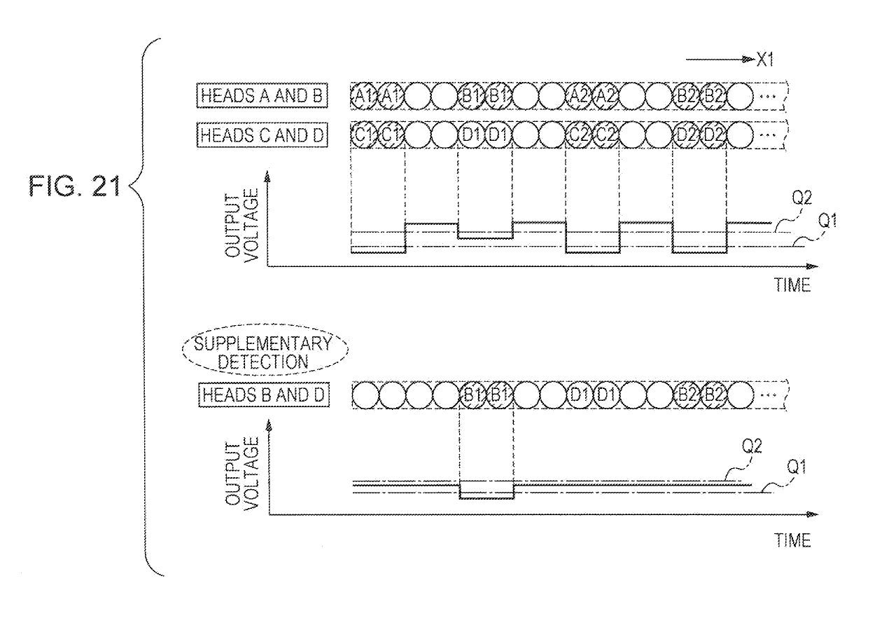

Next, as an example, in a case where four module heads 22, 22, . . . (the head A to the head D) are disposed, the detection operation when the discharge operations in the liquid discharging nozzles of the respective module heads 22, 22, . . . are intermittently performed at a double speed is illustrated (refer to FIG. 21). The head A to the head D are the liquid discharging heads which respectively discharge ink of different colors.

In FIG. 21, A1, A2, . . . denote the liquid discharging nozzles of the head A disposed in order from the detection start end side, B1, B2, . . . denote the liquid discharging nozzles of the head B disposed in order from the detection start end side, C1, C2, . . . denote the liquid discharging nozzles of the head C disposed in order from the detection start end side, and D1, D2, . . . denote the liquid discharging nozzles of the head D disposed in order from the detection start end side.

In A1, A2, . . . , B1, B2, . . . , C1, C2, . . . , and D1, D2, . . . , a state where ink has been discharged by the discharge operation is shown with hatching, and a state where ink has not been discharged even by the discharge operation is shown without hatching. In addition, for simplicity of explanation, the explanation of FIG. 21 is performed assuming that the detection of a discharge state regarding the liquid discharging nozzle is performed by the detection sensor 55 on one side.

The discharge, operations are continuously performed twice at the same time in the liquid discharging nozzle 1 (A1) of the head A and the liquid discharging nozzle 1 (C1) of the head C and after a certain time, the discharge operations are continuously performed twice at the same time in the liquid discharging nozzle 1 (B1) of the head B and the liquid discharging nozzle 1 (D1) of the head D. Subsequently, after a certain time, the discharge operations are continuously performed twice at the same time in the liquid discharging nozzle 2 (A2) of the head A and the liquid discharging nozzle 2 (C2) of the head C, and after a certain time, the discharge operations are continuously performed twice at the same time in the liquid discharging nozzle 2 (B2) of the head B and the liquid discharging nozzle 2 (D2) of the head D. This operation is also repeatedly intermittently performed in the liquid discharging nozzle 3 or later of each of the head A to the head D. Therefore, since the intermittent discharge operations of ink are respectively performed at the same time in the two head A and C and the two heads B and D, a period in which the discharge operation is not performed occurs intermittently. Further, twice of discharge operations are performed at double speed of the discharge, operations of FIGS. 15 to 18.

An example shown in FIG. 21 shows a state where discharge of ink from the liquid discharging nozzle 1 (D1) of the head D has not been performed. When discharge of ink has not been performed, since ink is not present in the luminous flux of the optical path S of the detection light from the light emitting section 53 toward the light sensing section 54, the output voltage at the time of detection rises. At this time, the first threshold voltage Q1 and the second threshold voltage Q2 are set and a discharge defect of the liquid discharging nozzle is detected.

However, when discharge of ink from the liquid discharging nozzle 1 (D1) of the head D has not been performed, since at the same time, the discharge operation is being performed in the liquid discharging nozzle 1 (B1) of the head B, at this point of time, it is possible to determine whether it is a discharge defect of the liquid discharging nozzle 1 (D1) of the head D or a discharge defect of the liquid discharging nozzle 1 (B1) of the head B.

Therefore, Specifying the liquid discharging nozzle in which a discharge defect, has been detected is performed by whether or not the output voltage higher than the first threshold voltage Q1 or the second threshold voltage Q2 is measured and the following supplementary detection.

The supplementary detection is performed, for example, by providing a separate detection sensor for supplement, from the detection sensor 55 at the liquid detection unit 500. Detection by the detection sensor for supplement is performed on the liquid discharging nozzles of either the heads A and C or the heads B and D. In an example of FIG. 21, the supplementary detection is performed on the liquid discharging nozzles of the heads B and D.

In the supplementary detection, the discharge operation is continuously performed twice in the liquid discharging nozzle 1 (B1) of the head B and after a certain time, the discharge operation is continuously performed twice in the liquid discharging nozzle 1 (D1) of the head D. Further, after a certain time, the discharge operation is continuously performed twice in the liquid discharging nozzle 2 (B2) of the head B, and after a certain time, the discharge operation is continuously performed twice in the liquid discharging nozzle 2 (D2) of the head D. This operation is also repeatedly intermittently performed in the liquid discharging nozzle 3 or later of each of the heads B and D.

An example of the supplementary detection shown in FIG. 21 shows a state where discharge of ink from the liquid discharging nozzle 1 (D1) of the head D has not been performed. By the measurement, of the above-mentioned output voltage and the result of the supplementary detection, it is detected that the liquid discharging nozzle 1 (D1) of the head D has a discharge defect.

By adopting the method as described above, it is possible to simultaneously detect the discharge states of ink with respect to the respective nozzles of the four module heads 22, 22, . . . by single movement of the liquid detection unit 500 from the detection start end up to the detection termination end.

Further, as described above, since in the discharge direction, a plurality of ink droplets are present in the luminous flux of the optical path S of the detection light by intermittently performing the discharge operation of ink at a double speed, the S/N ratio of a detection signal becomes large, so that it is possible to attain improvement in detection accuracy.

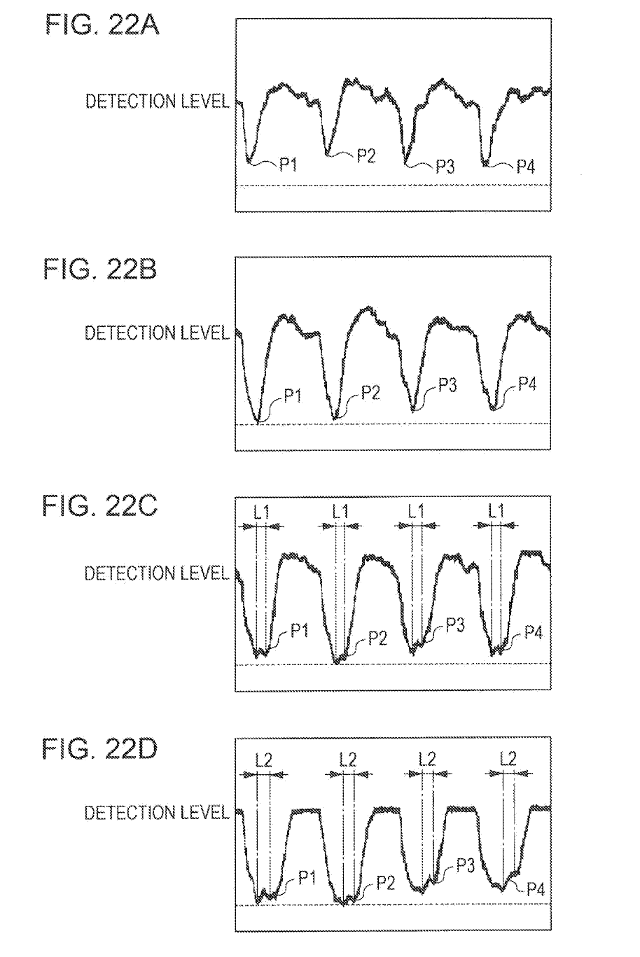

FIGS. 22A to 22D are diagrams illustrating waveforms of detection levels at the time of detection by the discharge detection section 52.

FIG. 22A shows a state when one drop of ink is discharged from the liquid discharging nozzle, FIG. 22B shows a state when two drops of ink are discharged at a double speed from the liquid discharging nozzle, FIG. 22C shows a state when three drops of ink are discharged at a double speed from the liquid discharging nozzle, and FIG. 22D shows a state when, four drops of ink are discharged at a double speed from the liquid discharging nozzle.

P1 to P4 in which the detection levels are changed are present in each of FIGS. 22A to 22D. However, P1 to P4 represent changes in detection level when a liquid droplet is present in the luminous flux.

In FIG. 22B, it can be understood that the changes in detection level of P1 to P4 are increased compared to FIG. 22A and two drops of ink are present in the luminous flux of the optical path S.

In FIG. 22C, compared to FIG. 22B, the magnitudes of the changes in detection level of P1 to P4 do not almost change and widths L1 of P1 to P4 are increased. Therefore, although two drops of ink are present in the optical path S, since three drops of ink are being discharged, it can be understood that two drops of ink which are discharged in sequence are present in the luminous flux of the optical path S and the time when two drops of ink are present in the luminous flex is prolonged.

In FIG. 22D, compared to FIG. 22B, the magnitudes of the changes in detection level of P1 to P4 do not almost change and widths L2 of P1 to P4 are increased further than those in FIG. 22C. Therefore, although two drops of ink are present in the optical path S, since, four drops of ink are being discharged, it can be understood that two drops of ink which are discharged in sequence are present in the luminous flux of the optical path S and a time when two drops of ink are present in the luminous flex is further prolonged.

Therefore, the S/N ratio of a detection signal becomes large by performing detection with respect to a plurality of liquid discharging nozzles (two liquid discharging nozzles in FIG. 20 and four liquid discharging nozzles in FIG. 21) shown in FIGS. 20 and 21 by the discharge detection section 52, so that it is possible to attain improvement in detection accuracy.

The Others

In the above, an example is shown in which the discharge states of ink regarding the liquid discharging nozzles present in the even-numbered chips among the head chips 23, 23, . . . and the discharge states of ink regarding the liquid discharging nozzles present in the odd-numbered chips are respectively detected by the detection sensor 55A and the detection sensor 55B (refer to FIG. 13).

At this time, since the head chips 23, 23, . . . are arranged in a zigzag manner, portions which overlap each other in the sub-scanning direction are present. However, the overlapping portions are simultaneously present in the luminous flux of one optical path S of the detection light.

However, the liquid discharging nozzles present in the overlapping portions are portions which overlap each other in the transport direction at the time of recording on the recording sheet 1000 and if at least one of the liquid discharging nozzles present in the overlapping portions is in a normal discharge state, it does not adversely affect recording on the recording sheet 1000.

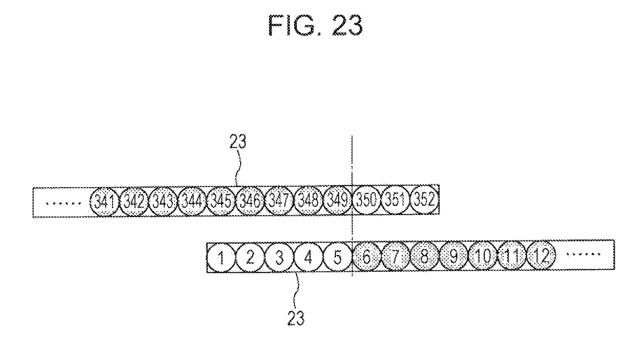

Therefore, in the case of detecting the discharge state of ink regarding the liquid discharging nozzle by the detection sensor 55 on one side, the discharge state of ink may be detected only with respect to one liquid discharging nozzle of the liquid discharging nozzles present in the overlapping portions (refer to FIG. 23).

In FIG. 23, 1, 2, 3, . . . denote the liquid discharging nozzles disposed in order from the detection start end side of the head chip 23 on one side and . . . , 350, 351, and 352 denote the liquid discharging nozzles disposed in order from the detection start end side of the head chip 23 on the other side.

In 1, 2, 3, . . . and . . . , 350, 351, and 352, the liquid discharging nozzle which becomes a detection target is shown with dots, and the liquid discharging nozzle which does hot become a detection target is shown without dots.

In this manner, by detecting the discharge state of ink only with respect to one liquid discharging nozzle of the liquid discharging nozzles present in the overlapping portions, it is possible to attain speed-up of the detection operation.

Relationship Between Cleaning Section and Discharge Detection Section

In the liquid discharging apparatus 1, in a case where ink is not discharged from the liquid discharging nozzles of the liquid discharging block 200 without performing the recording operation for a long period of time, there is concern that ink attached to the vicinity of the nozzle orifices of the liquid discharging surfaces 22a, 22a, . . . by the previous recording operation may evaporate and dry, thereby being thickened or solidified. Further, also in a case where the recording operation is performed frequently, there is concern that paper dust or dust may be attached to the liquid discharging surfaces 22a, 22a, . . . or ink by the previous recording operation may remain in the vicinity of the nozzle orifice. If such a problem occurs, discharge of ink from the liquid discharging nozzle is hindered, so that normal discharge of ink from the liquid discharging nozzle becomes difficult, causing poor discharge.

Therefore, at the liquid detection unit 500 of the liquid discharging apparatus 1, the cleaning section 56 is provided in addition to the discharge detection, section 52, and at the time of power-on of the liquid discharging apparatus 1 or for every certain amount of recording, by moving the cleaner 56c in a contact state with the liquid discharging surfaces 22a, 22a, . . . , the liquid discharging surfaces 22a, 22a, . . . are cleaned as follows.

The cleaning section 56 has a function in which the cleaner 56c is brought into contact with the liquid discharging surfaces 22a, 22a, . . . of the liquid discharging head 21, thereby cleaning the liquid discharging surfaces 22a, 22a, . . . . Therefore, cleaning by the cleaning section 56 may be performed on the liquid discharging nozzle in which a discharge defect has been detected by the detection by the discharge detection section 52, and the cleaning by the cleaning section 56 may also be performed before the detection by the discharge detection section 52 is performed.

Especially, at the time of movement of the liquid detection unit 500, by making the cleaning by the cleaning section 56 be performed ahead of the detection by the discharge detection section 52, the number of liquid discharging nozzles which are detected as having a discharge defect by the discharge detection section 52 is reduced.

Therefore, it is possible to attain simplification and speed-up of an operation of the discharge recovery treatment such as idling discharge or cleaning which is performed on the liquid discharging nozzle regarded as having a discharge defect after detection.

Further, in the liquid discharging apparatus 1, cleaning on the liquid discharging surfaces 22a, 22a, . . . by the cleaning section 56 may also be performed before, the preceding discharge which is performed ahead of the detection by the liquid detection unit 500 is performed.

In this manner, by performing cleaning ahead of the preceding discharge, the number of liquid discharging nozzles which are detected as having a discharge defect by the discharge detection section 52 is further reduced, so that it is possible to attain further simplification and further speed-up of an operation of the discharge recovery treatment such as idling discharge or cleaning which is performed on the liquid discharging nozzle, regarded as having a discharge defect after detection.

In addition, in the liquid discharging apparatus 1, it is also possible to make a configuration such that the preceding discharge is performed ahead of cleaning and subsequently, the detection by the liquid detection unit 500 is performed.

When the cleaning by the cleaning section 56 as described above is performed, the platen 300 is moved downward with respect to the liquid discharging block 200, so that a movement space for movement of the liquid detection unit 500 is formed between the platen 300 and the liquid discharging block 200.

If the cleaning by the cleaning section 56 is finished, the liquid detection unit 500 is held on the side of the platen 300, and the platen 300 is moved upward with respect to the liquid discharging block 200, so that the space between the platen 300 and the liquid discharging block 200 is formed as a transport space of the recording sheet 1000. At this time, when recording on the recording sheet 1000 by the liquid discharging block 200 is not performed, the capping section 600 is moved upward, so that the space between the platen 300 and the liquid discharging block 200 is hermetically sealed.

If the space between the platen 300 and the liquid discharging block 200 is hermetically sealed, the moisturizer is sent from the moisturizer storage section 71 to the moisturizer absorption section provided inside the platen 300 through the moisturizer supply tube 72 by the moisturizer supply pump 73 of the moisturizer supply section 700. Therefore, the space between the platen 300 and the liquid discharging block 200 is maintained in a wet state, so that drying of ink of the liquid discharging nozzles of the liquid discharging block 200 is prevented.

Effects or the Like of Liquid Discharging Apparatus

As described above, in the liquid discharging apparatus 1, the preceding discharge as the discharge recovery treatment which is the discharge operation of liquid from the nozzle orifice present in a certain area is performed ahead of detection of the discharge states of ink from the liquid discharging nozzles of the liquid discharging head 21 by the discharge detection section 52.

Therefore, the discharge recovery treatment for recovering normal discharge of ink from the liquid discharging nozzle and the detection by the discharge, detection section 52 are performed at the time of movement of the liquid detection unit 500, so that it is possible to attain simplification and speed-up of an operation of the discharge recovery treatment which is performed on the liquid discharging nozzle regarded as having a discharge defect after detection and also attain shortening of a detection time.

Further, since the preceding discharge and the detection by the discharge detection section 52 are performed at the time of movement of the liquid detection unit 500, the time from the preceding discharge up to the detection by the discharge detection section 52 is shortened, so that it is possible to prevent drying of ink present in the liquid discharging nozzle.

Further, at the discharge detection section 52, the light emitting sections 53 and 53 which emit the detection lights and the light sensing sections 54 and 54 which receive the detection lights are disposed being spaced apart in the sub-scanning direction, and a plurality of detection sensors 55 and 55 constituted by the combination of the light emitting sections 53 and 53 and the light, sensing sections 54 and 54 are arranged in the main scanning direction (the movement direction of the liquid detection unit 500).

Therefore, it is possible to respectively detect different liquid discharging nozzles provided at the liquid discharging head 21 by the plurality of detection sensors 55 and 55, so that it is possible to attain improvement in detection speed.

In addition, in the above, an example in which two detection sensors 55 and 55 are arranged has been illustrated. However, the number of detection sensors 55 is not limited to two and three or more detection sensors may also be arranged in the movement direction of the liquid detection unit 500.

Furthermore, since the light emitting sections 53A and 53B and the light sensing sections 54A and 54B are respectively alternately arranged in the movement direction of the liquid detection unit 500, the detection light emitted from the light emitting section 53A is not incident on the light sensing section 54B which is located in the movement direction of the liquid detection unit 500 and the detection light emitted from the light emitting section 53B is not incident on the light sensing section 54A which is located in the movement direction of the liquid detection unit 500.

Therefore, since a mutual optical interference does not occur in the detection sensor 55A and the detection sensor 55B, the distance between the detection sensor 55A and the detection sensor 55B can be shortened in the movement direction of the liquid detection unit 500, so that it is possible to attain a reduction in the size of the liquid discharging apparatus 1 due to a reduction in the size of the liquid detection unit 500.

Further, since a mutual optical interference does not occur in the detection sensor 55A and the detection sensor 55B, it is possible to prevent false detection by the preceding detection in the discharge detection section 52.

Further, since the head-chips 23, 23, . . . are arranged in a zigzag manner, by alternately arranging the light emitting sections 53A and 53B and the light sensing sections 54A and 54B in the movement direction of the liquid detection unit 500, it is possible to make a positional relationship of the detection sensor 55A to the even-numbered chip and a positional relationship of the detection sensor 55B to the odd-numbered chip symmetrical to each other. That is, it is possible, to make the distance from the detection sensor 55A to the even-numbered chip in the sub-scanning direction and the distance from the detection sensor 55B to the odd-numbered chip in the sub-scanning direction the same.

Therefore, variation in output characteristic does not easily occur with respect to the even-numbered chip and the odd-numbered chip which become detection targets in the detection sensor 55A and the detection sensor 55B, so that it is possible to attain improvement in detection accuracy by the detection sensors 55 and 55.

In addition, in the liquid discharging apparatus 1, the fixed line head extending in a direction perpendicular to the transport direction of the recording sheet is used as the liquid discharging head 21 and the liquid detection unit 500 is moved in the extending direction of the line head.

Therefore, since the liquid discharging head 21 is fixed, it is possible to secure excellent positional accuracy of the liquid detection unit 500 with respect to the liquid discharging head 21, so that it is possible to attain improvement in detection accuracy by the discharge detection section 52.

In addition, in the liquid discharging apparatus 1, a configuration is made such that the liquid detection unit 500 is moved in a direction perpendicular to the transport direction of the recording sheet 1000, whereby detection of the discharge states regarding the liquid discharging nozzles of the liquid discharging head 21 is performed.

Therefore, it is possible to perform detection, without depending on the size in the width direction (the main scanning direction) of the recording sheet 1000, so that it is possible to perform detection in response to various recording sheets having different widths.

All the specific forms and the structures of each section described in the above-described best, mode are merely to illustrate one example of an embodiment when carrying out the present disclosure, and the technical scope of the present disclosure should not be interpreted as being limited by these.

The present disclosure contains subject matter related to that disclosed in Japanese Priority Patent. Application JP 2010-211414 filed in the Japan Patent Office on Sep. 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharging apparatus comprising:
a liquid discharging head in which a plurality of liquid discharging nozzles which discharge liquid onto a recording sheet on the basis of image information are arranged and which has liquid discharging surfaces in which each nozzle orifice of the plurality of liquid discharging nozzles is arranged;
a platen that is disposed to face the liquid discharging surfaces of the liquid discharging head and retains the recording sheet in a state where the recording sheet faces the liquid discharging surfaces;
a liquid detection unit which is made to be able to move between the liquid discharging head and the platen in a state where the liquid detection unit faces the liquid discharging surfaces and which detects the discharge states of liquid from the liquid discharging nozzles at the time of movement; and
a unit driving mechanism which moves the liquid detection unit in a state where the liquid detection unit faces the liquid discharging surfaces,
wherein at the time of detection of the discharge states of liquid from the liquid discharging nozzles, the liquid detection unit is moved from a detection start end in which detection is started up to a detection termination end in which detection is finished, and
at the time of movement of the liquid detection unit, discharge operations of liquid from the nozzle orifices that are present in a certain area located at a certain distance in the detection termination end side from a detection position are performed ahead of detection by the liquid detection unit, and at the time of detection by the liquid detection unit, a discharge operation of liquid from the nozzle orifice of the liquid discharging nozzle that becomes a detection target is performed again.

2. The liquid discharging apparatus according to claim 1, wherein light emitting sections which emit detection lights that detect the discharge states of liquid from the liquid discharging nozzles and light sensing sections which receive the detection lights emitted from the light emitting sections are disposed at the liquid detection unit,
the light emitting sections and the light sensing sections are disposed being spaced apart in a direction perpendicular to a movement direction of the liquid detection unit and perpendicular to a discharge direction of liquid,
a detection sensor is constituted by the combination of the light emitting section and the light sensing section, and
the detection sensor is arranged in a plurality in the movement direction.

3. The liquid discharging apparatus according to claim 2, wherein the light emitting sections and the light sensing sections are alternately arranged in the movement direction.

4. The liquid discharging apparatus according to claim 1, wherein a fixed line head which extends in a direction perpendicular to the movement direction of the liquid detection unit is used as the liquid discharging head.

5. The liquid discharging apparatus according to claim 2, wherein the liquid detection unit includes a discharge detection section in which the light emitting sections and the light sensing sections are arranged and a cleaning section which cleans the liquid discharging surfaces of the liquid discharging head, and
cleaning by the cleaning section is performed ahead of detection by the discharge detection section at the time of movement of the liquid detection unit.

6. The liquid discharging apparatus according to claim 5, wherein the cleaning by the cleaning section is performed ahead of the discharge operations of liquid from the nozzle orifices which precede detection by the liquid detection unit.

7. The liquid discharging apparatus according to claim 1, wherein an absorber which absorbs liquid that is discharged from the liquid discharging nozzles is disposed at the liquid detection unit.

8. The liquid discharging apparatus according to claim 1, wherein the liquid discharging head includes a plurality of module heads in which colors that are discharged from the liquid discharging nozzles are respectively different and which are adjacently disposed in a direction perpendicular to the movement direction of the liquid detection unit and perpendicular to the discharge direction of liquid,
a discharge operation of liquid from each liquid discharging nozzle of each module head is intermittently performed once in order, and
a discharge operation of liquid from each liquid discharging nozzle of each module head is performed when a discharge operation of liquid from each liquid discharging nozzle of another module head is not performed.

9. The liquid discharging apparatus according to claim 1, wherein the liquid discharging head includes a plurality of module heads in which colors that are discharged from the liquid discharging nozzles are respectively different and which are adjacently disposed in a direction perpendicular to the movement direction of the liquid detection unit and perpendicular to the discharge direction of liquid, and
when the number of module heads is set to be n,
a discharge operation of liquid in each liquid discharging nozzle of each module head is performed n times in order, and
the start of discharge operations of liquid of the respective module heads adjacently disposed are performed being delayed once in order.
